(19) United States
(12) Patent Application Publication
(10) Pub. No.: US 2020/0298440 A1
(43) Pub. Date: Sep. 24, 2020

(54) METHOD FOR FORMING FLYING OBJECT USING OPTICAL VORTEX LASER, AND IMAGE FORMING METHOD AND APPARATUS

(71) Applicants: Jun Aoto, Kanagawa (JP); Muneaki Iwata, Kanagawa (JP); Kazumi Suzuki, Shizuoka (JP); Hiroyuki Suhara, Kanagawa (JP); Akihiro Kaneko, Shizuoka (JP); Takashige Omatsu, Chiba (JP); Ryosuke Nakamura, Chiba (JP)

(72) Inventors: Jun Aoto, Kanagawa (JP); Muneaki Iwata, Kanagawa (JP); Kazumi Suzuki, Shizuoka (JP); Hiroyuki Suhara, Kanagawa (JP); Akihiro Kaneko, Shizuoka (JP); Takashige Omatsu, Chiba (JP); Ryosuke Nakamura, Chiba (JP)

(21) Appl. No.: 16/820,323

(22) Filed: Mar. 16, 2020

(30) Foreign Application Priority Data
Mar. 20, 2019 (JP) 2019-052284
Oct. 30, 2019 (JP) 2019-197550

(51) Int. Cl. B28B 1/00; B29C 64/268; G02B 5/00; B41J 2/14

(52) U.S. Cl. CPC B28B 1/001; B29C 64/268; B41M 2205/08; B41J 2/14104; G02B 5/003

(57) ABSTRACT

Provided is a method for forming a flying body using optical vortex laser, the method including irradiating an opposite surface of a base to a surface of the base, on which a light-absorbing material is disposed, with an optical vortex laser beam to generate a liquid column or liquid droplet having a diameter smaller than an irradiation diameter of the optical vortex laser beam from the light-absorbing material in an irradiation direction of the optical vortex laser beam.

### CROSS-REFERENCE TO RELATED APPLICATIONS

The present application claims priority under 35 U.S.C. § 119 to Japanese Patent Application No. 2019-052284 filed Mar. 20, 2019 and Japanese Patent Application No. 2019-197550 filed Oct. 30, 2019. The contents of which are incorporated herein by reference in their entirety.

### BACKGROUND OF THE INVENTION

### Field of the Invention

The present disclosure relates to a method for forming a flying object using optical vortex laser, and an image forming method and apparatus.

### Description of the Related Art

Since an image forming apparatus can make ink droplets fly towards a desired position, applications of the image forming apparatus in the field of 3D printers where three-dimensional forming is performed, the field of printed electronics where electronic parts are formed by printing, etc. have been recently studied.

Specifically, it is desired that an image forming apparatus make various materials, as well as a low-viscous ink used for conventional image formation, fly accurately towards a desired position. To this end, various image forming apparatuses are proposed. For example, proposed is a method where a coating film of an ink having high viscosity is irradiated with typical laser to form protrusions of the ink along the direction of gravity, and the formed protrusions are brought into contact with a medium to print with the highly viscous material (see, for example, Unexamined Japanese Patent Application Publication No. 2018-56565).

### SUMMARY OF THE INVENTION

According to one aspect of the present disclosure, a method for forming a flying body using optical vortex laser including irradiating an opposite surface of a base to a surface of the base, on which a light-absorbing material is disposed, with an optical vortex laser beam to generate a liquid column or liquid droplet having a diameter smaller than an irradiation diameter of the optical vortex laser beam from the light-absorbing material in an irradiation direction of the optical vortex laser beam.

### BRIEF DESCRIPTION OF THE DRAWINGS

FIG. 1A is a schematic view illustrating one example of a wavefront (equiphase surface) of a typical laser beam;

FIG. 1B is a view illustrating one example of a light intensity distribution of a typical laser beam;

FIG. 1C is a view illustrating one example of a phase distribution of a typical laser beam;

FIG. 2A is a schematic view illustrating one example of a waterfront (equiphase surface) of an optical vortex laser beam;

FIG. 2B is a view illustrating one example of a light intensity distribution of an optical vortex laser beam;

FIG. 2C is a view illustrating one example of a phase distribution of an optical vortex laser beam;

FIG. 3A is a photograph illustrating one example where a light-absorbing material is irradiated with a typical laser beam;

FIG. 3B is a photograph illustrating one example where a light-absorbing material is irradiated with an optical vortex laser beam;

FIG. 4A is an explanatory view illustrating one example of a result of an interference measurement of an optical vortex laser beam;

FIG. 4B is an explanatory view illustrating one example of a result of an interference measurement of a laser beam having a point of light intensity of 0 at a center;

FIG. 5A is an explanatory view illustrating one example of the image forming apparatus of the present disclosure;

FIG. 5B is an explanatory view illustrating another example of the image forming apparatus of the present disclosure;

FIG. 5C is an explanatory view illustrating another example of the image forming apparatus of the present disclosure;

FIG. 6A is a schematic cross-sectional view illustrating one example of the image forming apparatus illustrated in FIG. 5B, to which a light-absorbing material supplying unit and a depositing target transporting unit are added;

FIG. 6B is a schematic cross-sectional view illustrating another example of the image forming apparatus illustrated in FIG. 5B, to which a light-absorbing material supplying unit and a depositing target transporting unit are added;

FIG. 7A is a schematic cross-sectional view illustrating one example of the image forming apparatus illustrated in FIG. 6A, to which a fixing unit is added;

FIG. 7B is a schematic cross-sectional view illustrating another example of the image forming apparatus illustrated in FIG. 6A, to which a fixing unit is added;

FIG. 7C is a schematic cross-sectional view illustrating another example of the image forming apparatus illustrated in FIG. 6A, to which a fixing unit is added;

FIG. 8A is a schematic cross-sectional view illustrating one example of the image forming apparatus of the present disclosure;

FIG. 8B is a schematic cross-sectional view illustrating another example of the image forming apparatus of the present disclosure;

FIG. 9 is a schematic cross-sectional view illustrating one example of a production device of a three-dimensional object;

FIG. 10A is a photograph illustrating a flying state of the light-absorbing material in Example 1;

FIG. 10B is a photograph illustrating a deposited state of the light-absorbing material in Example 1;

FIG. 11A is a photograph illustrating a flying state of the light-absorbing material in Example 2;

FIG. 11B is a photograph illustrating a deposited state of the light-absorbing material in Example 2;

FIG. 12A is a photograph illustrating a flying state of the light-absorbing material in Example 3;

FIG. 12B is a photograph illustrating a deposited state of the light-absorbing material in Example 3;

FIG. 13A is a photograph illustrating a flying state of the light-absorbing material in Example 4;

FIG. 13B is a photograph illustrating a deposited state of the light-absorbing material in Example 4;

FIG. 14A is a photograph illustrating a flying state of the light-absorbing material in Comparative Example 1;

FIG. 14B is a photograph illustrating a deposited state of the light-absorbing material in Comparative Example 1;

FIG. 15A is a photograph illustrating a flying state of the light-absorbing material in Comparative Example 2;

FIG. 15B is a photograph illustrating a deposited state of the light-absorbing material in Comparative Example 2;

FIG. 16 is a photograph illustrating a deposited state of the light-absorbing material in Example 5;

FIG. 17 is a photograph illustrating a deposited state of the light-absorbing material in Example 6; and

FIG. 18 is a photograph illustrating a deposited state of the light-absorbing material in Example 7.

### DESCRIPTION OF THE EMBODIMENTS

### (Method for Forming Flying Body Using Optical Vortex Laser, Image Forming Method, and Image Forming Apparatus)

The method for forming a flying body using optical vortex laser of the present disclosure includes irradiating an opposite surface of a base to a surface of the base, on which a light-absorbing material is disposed, with an optical vortex laser beam to generate a liquid column or liquid droplet having a diameter smaller than an irradiation diameter of the optical vortex laser beam from the light-absorbing material in an irradiation direction of the optical vortex laser beam.

The image forming method of the present disclosure includes: irradiating an opposite surface of a base to a surface of the base, on which a light-absorbing material is disposed, with an optical vortex laser beam to generate a liquid column or a liquid droplet having a diameter smaller than an irradiation diameter of the optical vortex laser beam from the light-absorbing material in an irradiation direction of the optical vortex laser beam; and bringing the liquid column or the liquid droplet into contact with a transfer medium to transfer the liquid column or the liquid droplet onto the transfer medium.

Specifically, the image forming method of the present disclosure includes bringing a liquid column or liquid droplet having a small diameter formed from a light-absorbing material according to the method for forming a flying body using optical vortex laser of the present disclosure into contact with a transfer medium to transfer the liquid column or liquid droplet onto the transfer medium.

Accordingly, the method for forming a flying body using optical vortex laser of the present disclosure is covered by descriptions of the image forming method of the present disclosure. For this reason, details of the method for forming a flying body using optical vortex laser of the present disclosure will be clarified through the descriptions of the image forming method of the present disclosure.

The present disclosure has an object to provide a method for forming a flying object using optical vortex laser, where the method can form a high resolution image.

The present disclosure can provide a method for forming a flying object using optical vortex laser, where the method can form a high resolution image.

The image forming method of the present disclosure has been accomplished based on the following insights. That is, according to a method for forming an image using laser in the related art, it is not easy to make lengths of protrusions constant, and therefore an area to be in contact with a medium varies and an image of high resolution may not be formed.

Moreover, the image forming method of the present disclosure has been accomplished based on the following insights. That is, an ink tends to be scattered as a diameter of laser for use in the related art is reduced, and therefore an image of high resolution may not be formed.

Furthermore, the image forming method of the present disclosure has been accomplished based on the following insights. That is, according to a method for forming an image using laser in the related art, straight protrusions of an ink are formed only in the direction of gravity and therefore a degree of freedom in designing a device may be limited.

According to the image forming method of the present disclosure, when a coating film of the light-absorbing material is irradiated with an optical vortex laser beam, an edge of the light-absorbing material hemispherically swollen in the irradiate direction is projected or made fly as being torn off, while rotating part of the light-absorbing material. In other words, according to the image forming method of the present disclosure, when the surface of the base is irradiated with the optical vortex laser beam, the light-absorbing material is swollen in a substantially dorm shape in the irradiation direction of the optical vortex laser beam along the rotational movement of the light-absorbing material, and a liquid column or liquid droplet having a diameter smaller than the irradiation diameter of the optical vortex laser beam is generated from an apex of the substantially dorm-shaped light-absorbing material.

Moreover, the image forming method of the present disclosure can form an image of high resolution by bringing the liquid column or liquid droplet generated from the light-absorbing material into contact with a transfer medium to transfer the liquid column or liquid droplet thereof.

First, the optical vortex laser beam will be described.

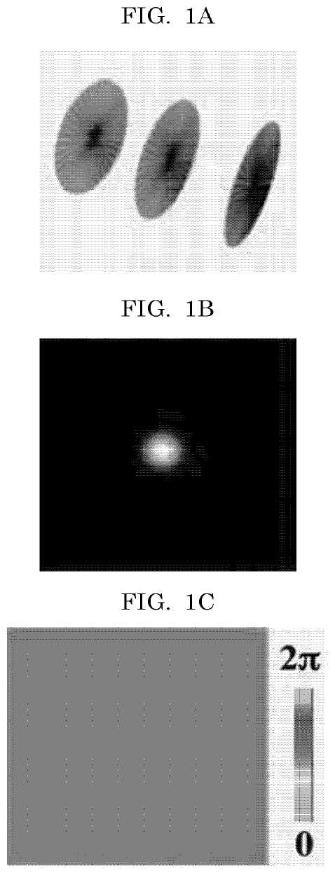

Since a general laser beam has uniform phases, the laser beam has a planar equiphase surface (wavefront) as depicted in FIG. 1A. The direction of the pointing vector of the laser beam is the orthogonal direction of the planar equiphase surface. Accordingly, the direction of the pointing vector of the laser beam is identical to the irradiation direction of the laser beam. When the light-absorbing material is irradiated with the laser beam, therefore, the force acts on the light-absorbing material in the irradiation direction. However, the light intensity of the cross-section of the layer beam has a normal distribution (Gaussian distribution) where light intensity is the maximum at a center of the beam as depicted in FIG. 1B. Therefore, the light-absorbing material tends to be scattered. When observation of the phase distribution is performed, it is confirmed that there is no phase difference as depicted in FIG. 1C.

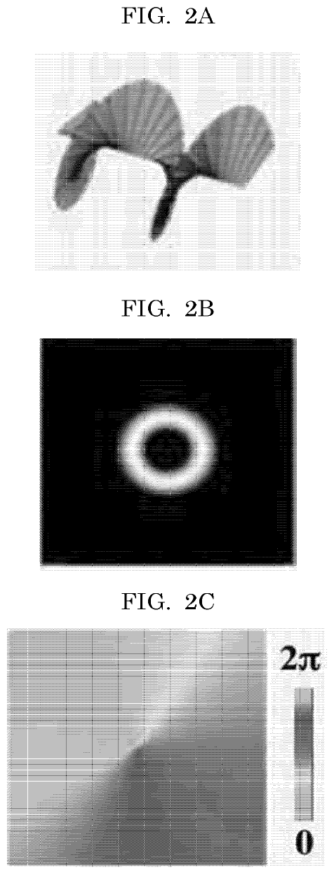

On the other hand, an optical vortex laser beam has a spiral equiphase surface as depicted in FIG. 2A. Since the pointing vector of the optical vortex laser beam is a direction orthogonal to the spiral equiphase surface, a force acts in an orthogonal direction when the light-absorbing material is irradiated with the optical vortex laser beam. Therefore, the light intensity distribution thereof is a doughnut-shaped distribution where a center of the beam is 0 and recessed as depicted in FIG. 2B. The doughnut-shaped energy is applied as radiation pressure to the light-absorbing material irradiated with the optical vortex laser beam. As a result, the light-absorbing material irradiated with the optical vortex laser beam is made fly in the irradiation direction of the optical vortex laser beam and is then deposited on a depositing target without scattering easily. When observation of the phase distribution is performed, moreover, it is confirmed that a phase difference is generated as depicted in FIG. 2C.

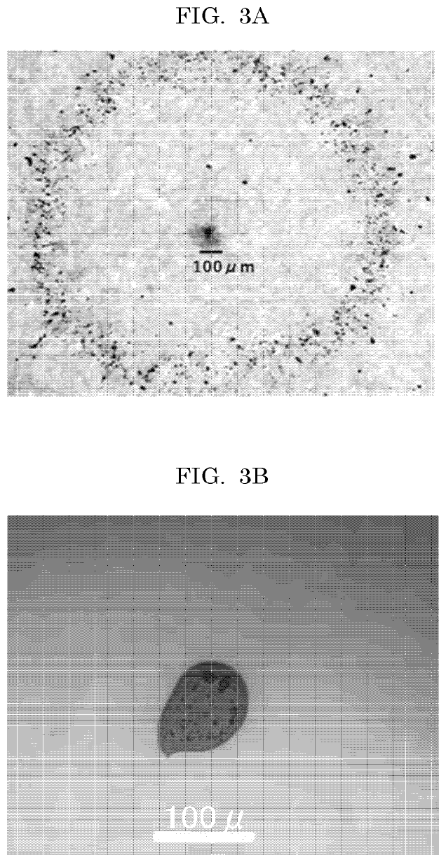

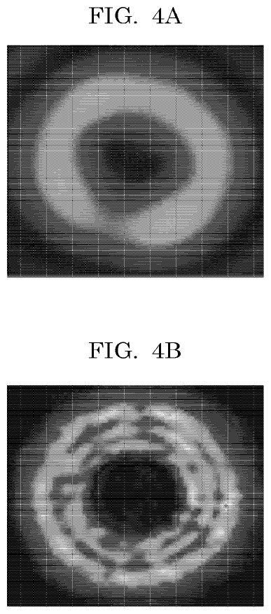

FIG. 3A is a photograph depicting one example where a light-absorbing material is irradiated with a typical laser beam. FIG. 3B is a photograph depicting one example where a light-absorbing material is irradiated with an optical vortex laser beam.

Comparing between FIG. 3A and FIG. 3B, it can be confirmed that the light-absorbing material is scattered more in FIG. 3A than FIG. 3B. It can be understood from FIGS. 3A and 3B that the light-absorbing material irradiated with the optical vortex laser beam receives doughnut-shaped energy as radiation pressure to fly in the radiation direction of the optical vortex laser beam and the light-absorbing material is deposited on a depositing target without scattering easily.

A method for judging whether the laser beam is an optical vortex laser beam or not is not particularly limited and may be appropriately selected depending on the intended purpose. Examples thereof include observation of the above-described phase distribution, and a measurement of interference. The measurement of interference is typically used.

The measurement of interference can be performed by observing using a laser beam profiler (e.g., a laser beam profiler available from Ophir-Spiricon, Inc., and a laser beam profiler available from Hamamatsu Photonics K.K.). Examples of the results of the measurement of interference are depicted in FIGS. 4A and 4B.

FIG. 4A is an explanatory view illustrating one example of a result of a measurement of interference of an optical vortex laser beam. FIG. 4B is an explanatory view illustrating one example of a result of a measurement of interference of a laser beam having a point at which light intensity is 0 at a center thereof.

It can be confirmed from the interference measurement of the optical vortex laser beam that the energy distribution is a doughnut shape as depicted in FIG. 4A, and the optical vortex laser beam is a laser beam having a point at which light intensity of 0 at a center thereof similarly to FIG. 1C.

On the other hand, it can be confirmed from the interference measurement of the typical laser beam having a point at which light intensity is 0 at a center thereof that the doughnut-shaped energy distribution is not even as depicted in FIG. 4B although it is similar to the energy distribution obtained by the interference measurement of the optical vortex laser beam depicted in FIG. 4A, and therefore a difference with the optical vortex laser beam can be confirmed.

The image forming method of the present disclosure can be suitably performed by the image forming apparatus of the present disclosure.

The image forming apparatus of the present disclosure is configured to irradiate a surface of a base that is opposite to a surface thereof on which a light-absorbing material is disposed with an optical vortex laser beam. As a result, the image forming apparatus of the present disclosure is configured to generate a liquid column or liquid droplet having a diameter smaller than an irradiation diameter of the optical vortex laser beam from the light-absorbing material in an irradiation direction of the optical vortex laser beam, and to bring the liquid column or liquid droplet into contact with a transfer medium to transfer the liquid column or liquid droplet to the transfer medium.

The image forming apparatus includes a light-absorbing material flying unit and a transferring unit, and preferably further includes other units according to the necessity.

### <Light-Absorbing Material Flying Unit>

The light-absorbing material flying unit is a unit configured to irradiate an opposite surface of a base to a surface of the base, on which a light-absorbing material is disposed, with an optical vortex laser beam to generate a liquid column or a liquid droplet having a diameter smaller than an irradiation diameter of the optical vortex laser beam from the light-absorbing material in an irradiation direction of the optical vortex laser beam.

As the light-absorbing material flying unit, for example, a unit including a laser light source, an optical vortex converting unit, and a wavelength converting unit can be used. The light-absorbing material flying unit preferably further includes other members according to the necessity.

### <<Laser Light Source>>

The laser light source is not particularly limited and may be appropriately selected depending on the intended purpose. Examples of the laser light source include a solid-state laser, a gas laser, and a semiconductor laser. The laser light source is preferably a laser light source capable of oscillating pulses.

Examples of the solid-state laser include a YAG laser and a titanium-sapphire laser.

Examples of the gas laser include an argon laser, a helium neon laser, and a carbon dioxide laser.

Among the above-listed examples, the semiconductor laser having an output of about 30 mW is preferable in terms of downsizing and cost-saving of the apparatus. However, in Examples, a titanium-sapphire laser was used experimentally.

A wavelength of the laser beam is not particularly limited and may be appropriately selected depending on the intended purpose. The wavelength thereof is preferably 300 nm or longer but 11 μm or shorter, and more preferably 350 nm or longer but 1,100 nm or shorter.

A beam diameter of the laser beam is not particularly limited and may be appropriately selected depending on the intended purpose. The beam diameter thereof is preferably 10 μm or greater but 10 mm or less, and more preferably 10 μm or greater but 1 mm or less.

A pulse width of the laser beam is not particularly limited and may be appropriately selected depending on the intended purpose. The pulse width is preferably 2 nanoseconds or greater but 100 nanoseconds or less, and more preferably 2 nanoseconds or greater but 10 nanoseconds or less.

A frequency of the pulse of the laser beam is not particularly limited and may be appropriately selected depending on the intended purpose. The frequency thereof is preferably 10 Hz or greater but 200 Hz or less, and more preferably 20 Hz or greater but 100 Hz or less.

Note that, the laser light source may be a laser light source capable of outputting an optical vortex laser beam.

### <<Optical Vortex Converting Unit>>

The optical vortex converting unit is not particularly limited and may be appropriately selected depending on the intended purpose, as long as the optical vortex converting unit can convert a laser beam into an optical vortex laser beam. Examples of the optical vortex converting unit include a diffractive optical element, a multimode fiber, and a liquid-crystal phase modulator.

Examples of the diffractive optical element include a spiral phase plate and a hologram element. Among the above-listed examples, a spiral phase plate is preferable.

The method for generating the optical vortex laser beam is not limited to the method using the optical vortex converting unit. Other examples thereof include a method for oscillating an optical vortex from a laser oscillator as an eigenmode, and a method for inserting a hologram element into an oscillator. Other examples of the method for generating the optical vortex laser beam include a method for using excitation liquid converted to a doughnut beam, a method for using a resonator mirror having a scotoma, and a method for oscillating an optical vortex mode utilizing a thermal lens effect generated by a side-pumped solid-state laser as a spatial filter.

### <<Wavelength Converting Unit>>

The wavelength converting unit is not particularly limited and may be appropriately selected depending on the intended purpose, as long as the total torque J_{L,S} represented by the formula (1) below can satisfy the condition |J_{L,S}|≥0 as a result that circular polarization is imparted to the optical vortex laser beam. Examples of the wavelength converting unit include a quarter wave plate. In case of the quarter wave plate, oval circular polarization (elliptic polarization) may be imparted by setting an optical axis to an angle other than +45° or −45°, but circular polarization of a true circle is preferably imparted by setting the optical axis to +45° or −45° to satisfy the conditions described above. As a result, the image forming apparatus can increase an effect of stably making the light-absorbing material fly to deposit the light-absorbing material on the depositing target without scattering easily.

$${J}_{L , S} = {ɛ}_{0} \{ ω LI - \frac{1}{2} ω Sr \frac{\partial I}{\partial r} \} \qquad ( 1 )$$

In the formula (1), co is a dielectric constant in vacuum, w is an angular frequency of light, L is a topological charge, I is an orbital angular momentum corresponding to the degree of vortex of the optical vortex laser beam represented by the following mathematical formula (2), S is a spin angular momentum corresponding to circular polarization, and r is a radius vector of the cylindrical coordinates system.

$$I ( r ) = {r}^{( 2 \vert L \vert )} exp ( - \frac{{r}^{2}}{{ω}_{0}^{2}} ) \qquad ( 2 )$$

In the formula (2), Wo is a beam waist size of light.

Note that, the topological charge is a quantum number expressed by the periodic boundary condition of the orientation direction in the cylindrical coordinates system of the optical vortex laser beam. Moreover, the beam waist size is the minimum value of the beam diameter of the optical vortex laser beam.

L is a parameter determined by the number of turns of the spiral wavefront of the wave plate. S is a parameter determined by the direction of circular polarization of the wave plate. Note that, L and S are both integers. Moreover, the signs of L and S represent directions of spiral (e.g., clockwise, and anticlockwise), respectively.

Note that, J=L+S, when the total torque of the optical vortex laser beam is determined as J.

Since the image forming apparatus includes an optical vortex converting unit configured to convert a laser beam into an optical vortex laser beam and a wavelength converting unit configured to impart circular polarization to the optical vortex laser beam and is set to |J_{LS}|≥0, for example, linear orientation of flying bodies of the highly viscous or solid light-absorbing material can be realized and scattering of the light-absorbing material can be suppressed.

### <<Other Members>>

Other members are not particularly limited and may be appropriately selected depending on the intended purpose. Examples thereof include a beam diameter changing member, a beam wavelength changing element, and an output adjusting unit.

### —Beam Diameter Changing Member—

The beam diameter changing member is not particularly limited and may be appropriately selected depending on the intended purpose, as long as the beam diameter changing member can change a beam diameter of a laser beam or an optical vortex laser beam. Examples thereof include a condenser lens.

A beam diameter (irradiation diameter) of the optical vortex laser beam is not particularly limited and may be appropriately selected depending on the intended purpose. The beam diameter thereof is preferably 100 μm or less. The irradiation diameter of the optical vortex laser beam being 100 μm or less is preferable because an image of high resolution can be easily formed.

Note that, the beam diameter can be changed with a laser spot diameter and a condenser lens.

In the case where the light-absorbing material is dispersoids, moreover, a diameter of the beam is preferably equal to or greater than the maximum value of the volume average particle diameter of the light-absorbing material, and more preferably 3 times the maximum value of the average particle diameter of the dispersoids. When the diameter of the beam is within the preferable range, it is advantageous because the light-absorbing material can be made fly stably.

### —Beam Wavelength Changing Element—

The beam wavelength changing element is not particularly limited and may be appropriately selected depending on the intended purpose, as long as the beam wavelength changing element can change a wavelength of a laser beam or an optical vortex laser beam into a wavelength that can be absorbed by the light-absorbing material, and can be transmitted through the base described later. Examples of the beam wavelength changing element include a KTP crystal, a BBO crystal, a LBO crystal, and a CLBO crystal.

### —Output Adjusting Unit—

The output adjusting unit is not particularly limited and may be appropriately selected depending on the intended purpose, as long as the output adjusting unit can adjust a laser beam or an optical vortex laser beam to an appropriate output value. Examples thereof include glass.

An output value of the optical vortex laser beam applied to the light-absorbing material is not particularly limited and may be appropriately selected depending on the intended purpose, as long as a state where a liquid column converged to have a diameter smaller than the irradiation diameter with rotating around a central axis of irradiation diameter having the irradiation direction as an axis is generated, or a state where part of the light-absorbing material is cut off to generate a liquid droplet can be realized. Note that, the “output value” may be referred to as “irradiation energy” hereinafter.

An appropriate value of the irradiation energy of the optical vortex laser beam varies a viscosity of a film thickness of the light-absorbing material, and therefore the irradiation energy is preferably appropriately adjusted. Specifically, the irradiation energy is more preferably 100 μJ/dot or less, and even more preferably 60 μJ/dot or less. When the irradiation energy of the optical vortex laser beam is 60 μJ/dot or less, it is advantageous because a state where a liquid column converged to have a diameter smaller than the irradiation diameter with rotating around a central axis of irradiation diameter having the irradiation direction as an axis is generated, or a state where part of the light-absorbing material is cut off to generate a liquid droplet is easily realized.

### <Transferring Unit>

The transferring unit is a unit configured to bring the liquid column or liquid droplet having a diameter smaller than the irradiation diameter of the optical vortex laser beam generated from the light-absorbing material into contact with a transfer medium to transfer the liquid column or liquid droplet onto the transfer medium.

The transferring unit is not particularly limited and may be appropriately selected depending on the intended purpose. Examples of the transferring unit include a unit including a system by which a liquid column or liquid droplet generated from the light-absorbing material is brought into contact with a transfer medium. Specifically, the transferring unit may include, for example, a system for adjusting a gap between a depositing target and the light-absorbing material, or a system for transporting a depositing target.

### <<Transfer Medium>>

The transfer medium (depositing target) is not particularly limited and may be appropriately selected depending on the intended purpose, as long as the transfer medium can be brought into contact with a liquid column or liquid droplet generated from the light-absorbing material.

Examples of the transfer medium include recording media and intermediate transfer belts used in image forming apparatuses.

### <Other Units>

Examples of other units include a light-absorbing material supplying unit, a beam scanning unit, a depositing target transporting unit, a fixing unit, and a controlling unit.

Moreover, the light-absorbing material flying unit, the base, the light-absorbing material supplying unit, and the beam scanning unit are collectively handled as a light-absorbing body flying unit.

Examples of the above-mentioned other steps include a light-absorbing material supplying step, a beam scanning step, a depositing target transporting step, a fixing step, and a controlling step.

The light-absorbing material supplying unit is not particularly limited and may be appropriately selected depending on the intended purpose, as long as the light-absorbing material supplying unit can supply the light-absorbing material on a light path of the optical vortex laser beam between the light-absorbing material flying unit and the depositing target. The light-absorbing material supplying unit may be configured, for example, to supply the light-absorbing material via a cylindrical base disposed on the light path.

In the case where the light-absorbing material is a liquid and the light-absorbing material is supplied to the base, specifically, a supply roller and a regulating blade are preferably disposed as the light-absorbing material supplying unit because the light-absorbing material can be supplied with a constant average thickness onto a surface of the base using an extremely simple structure.

In this case, part of a surface of the supply roller is dipped in a storage tank storing the light-absorbing material, the supply roller rotates with bearing the light-absorbing material on the surface thereof, and comes into contact with the base to supply the light-absorbing material. The regulating blade is disposed downstream of the storage tank in the rotational direction of the supply roller, and is configured to regulate the light-absorbing material born on the supply roller to level the average thickness and to stabilize an amount of the light-absorbing material to be flown. Since the amount of the light-absorbing material to be flown can be reduced by making the average thickness extremely thin, the light-absorbing material can be deposited as fine dots on the depositing target with suppressing scattering, to thereby prevent dot gain that is a phenomenon that halftone dots are thicken. Note that, the regulating blade may be disposed downstream of the supply roller in the rotational direction of the base.

In the case where the light-absorbing material has high viscosity, moreover, a material of the supply roller preferably has elasticity at least at a surface thereof in order to securely make a contact with the base. In the case where the light-absorbing material has relatively low viscosity, examples of the supply roller include rollers used in precision wet coating, such as a gravure roller, a microgravure roller, and a forward roller.

Moreover, the light-absorbing material supplying unit that does not include a supply roller may form a layer of the light-absorbing material on a surface of the base by scraping the excessive light-absorbing material with a wiper etc. after bringing the base directly into contact with the light-absorbing material inside the storage tank. Note that, the storage tank may be disposed separately from the light-absorbing material supplying unit, and may be configured to supply the light-absorbing material to the light-absorbing material supplying unit with a hose etc.

The light-absorbing material supplying step is not particularly limited and may be appropriately selected depending on the intended purpose, as long as the light-absorbing material supplying step is a step including supplying the light-absorbing material on the light path of the optical vortex laser beam between the light-absorbing material flying unit and the deposition target. For example, the light-absorbing material supplying step can be suitably performed by the light-absorbing material supplying unit.

The beam scanning unit is not particularly limited and may be appropriately selected depending on the intended purpose, as long as the beam scanning unit is capable of scanning an optical vortex laser beam relative to the light-absorbing material. For example, the beam scanning unit may include a reflector configured to reflect an optical vortex laser beam emitted from the light-absorbing material flying unit towards the light-absorbing material, and a reflector driving unit configured to change an angle and position of the reflector to scan the optical vortex laser beam relative to the light-absorbing material.

The beam scanning step is not particularly limited and may be appropriately selected depending on the intended purpose, as long as the beam scanning step is a step including scanning an optical vortex laser beam relative to the light-absorbing material. For example, the beam scanning step can be suitably performed by the beam scanning unit.

The depositing target transporting unit is not particularly limited and may be appropriately selected depending on the intended purpose, as long as the depositing target transporting unit can transport a depositing target. Examples thereof include a pair of transport rollers.

The depositing target transporting step is not particularly limited and may be appropriately selected depending on the intended purpose, as long as the depositing target transporting step is a step including transporting a depositing target. For example, the depositing target transporting step can be suitably performed by the depositing target transporting unit.

The fixing unit is not particularly limited and may be appropriately selected depending on the intended purpose, as long as the fixing unit can fix the light-absorbing material deposited on the depositing target. Examples thereof include a fixing unit of a thermal compression bonding system using a heat press member.

The heat press member is not particularly limited and may be appropriately selected depending on the intended purpose. Examples thereof include a heating roller, a press roller, and a combination of a heating roller and a press roller. Another examples of the heat press member include a combination of the above-listed members with a fixing belt, and a combination of the above-listed members where the heating roller is replaced with a heating block.

The press roller is preferably a press roller a press surface of which travels at the same speed as the transporting speed of the depositing target by the depositing target transporting unit because deterioration of an image due to abrasion can be prevented. Among the above-listed examples, a press roller, in which an elastic layer is formed near the surface thereof, is more preferable because it is easy to bring into contact with and press the depositing target. Moreover, a press roller, in which a water-repellent surface layer is formed of a material having low surface energy, such as a silicone-based water repellent material and a fluorine compound, at the outermost surface thereof, is particularly preferable because disturbance of an image due to deposition of the light-absorbing material on the surface thereof can be prevented.

Examples of the water-repellent surface layer formed of the silicone-based water-repellent material include a film of a silicone-based release agent, a fired film formed of a silicone oil or various modified silicone oil, a film of silicone varnish, a film of silicone rubber, and a film of a composition, which includes silicone rubber with various metals, rubber, plastics, ceramics, etc.

Examples of the water-repellent surface layer formed of the fluorine compound include a film of a fluorine resin, a film of an organic fluorine compound, fired film or adsorption film of fluorine oil, a film of fluororubber, and a film of a composition, which includes fluororubber with various metals, rubber, plastics, ceramics, etc.

A heating temperature of the heating roller is not particularly limited and may be appropriately selected depending on the intended purpose. The heating temperature thereof is preferably 80° C. or higher but 200° C. or lower.

The fixing belt is not particularly limited and may be appropriately selected depending on the intended purpose, as long as the fixing belt has heat resistance and high mechanical strength. Examples thereof include films of polyimide, PET, PEN, etc. Moreover, the fixing belt preferably uses a material identical to a material constituting the outermost surface of a press roller in order to suppress disturbance of an image due to deposits of the light-absorbing material on the surface of the fixing belt. Energy for heating the fixing belt itself can be reduced by reducing a thickness of the fixing belt, and therefore the fixing belt can be immediately used once the power source is turned on. The temperature and pressure vary depending on a composition of the light-absorbing material to be fixed. The temperature is preferably 200° C. or lower in view of energy saving. The pressure is preferably 1 kg/cm or less in view of rigidity of the apparatus.

In the case where two or more light-absorbing materials are used, fixing may be performed every time the light-absorbing material of each color is deposited on the depositing target, or fixing may be performed in a state where all of the light-absorbing materials are deposited and laminated on the depositing target.

In the case where viscosity of the light-absorbing material is high and thus drying speed is slow and it is difficult to improve a deposition speed on a depositing target, moreover, the depositing target may be additionally heated to accelerate drying.

In the case where permeation and wetting of the light-absorbing material to the depositing target are slow, and drying is performed in the state where the deposited light-absorbing material is not sufficiently smoothed, a surface of the depositing target to which the light-absorbing material is deposited becomes rough. Therefore, glossiness of the surface of the depositing target may not be obtained. In order to obtain glossiness of the surface of the depositing target, surface roughness of the depositing target may be reduced by performing fixing using the fixing unit configured to pressurize to fix with pressurizing the light-absorbing material deposited on the depositing target while crushing the light-absorbing material.

The fixing unit is used to fix the light-absorbing material onto the depositing target, especially when a solid light-absorbing material formed by compressing a powder is used. Optionally, a known photofixing device may be used in combination with the fixing unit.

The fixing step is not particularly limited and may be appropriately selected depending on the intended purpose, as long as the fixing step is a step including fixing the light-absorbing material deposited on the depositing target. For example, the fixing step can be suitably performed by the fixing unit.

The controlling unit is not particularly limited and may be appropriately selected depending on the intended purpose, as long as the controlling unit is capable of controlling operations of each of the units. Examples thereof include devices, such as a sequencer, and a computer.

The controlling step is a step including controlling each of the steps, and can be suitably performed by the controlling unit.

### <Light-Absorbing Material>

The light-absorbing material includes a light-absorbing substance, and may further include other substances appropriately selected depending on the intended purpose.

The absorbance of the light-absorbing material to a wavelength of the optical vortex laser beam is preferably greater than 1, and more preferably greater than 2. It is advantageous when the absorbance of the light-absorbing material to a wavelength of the optical vortex laser beam is greater than 2 because energy efficiency can be enhanced.

### <<Light-Absorbing Substance>>

The light-absorbing substance is not particularly limited and may be appropriately selected depending on the intended purpose, as long as the light-absorbing substance absorbs light of a certain wavelength. Examples of the light-absorbing substance include colorants, such as pigments and dyes.

The absorption performance of the light-absorbing substance against light having a predetermined wavelength is not particularly limited and may be appropriately selected depending on the intended purpose. The transmittivity (absorbance) thereof in the state of a coating film having a film thickness of 3 μm is preferably 80% or less (0.1 or greater), more preferably 50% or less (0.3 or greater), and particularly preferably 30% or less (0.5 or greater).

Moreover, the transmittivity (absorbance) of the film formed of the light-absorbing material having light absorbing properties with the above-mentioned thickness is preferably 10% or less (1 or greater), more preferably 1% or less (2 or greater), even more preferably 0.1% or less (3 or greater), and particularly preferably 0.01% or less (4 or greater). When the transmittivity is within the preferable range, it is advantageous because the energy of the optical vortex laser beam absorbed by the base is not easily converted into heat and therefore no change may occur in the light-absorbing material, such as drying and melting. When the transmittivity is within the preferable range, moreover, it is advantageous because the energy applied to the light-absorbing material is not easily decreased, and therefore the deposition position rarely varies.

Note that, the transmittivity (absorbance) can be measured, for example, by means of a spectrophotometer (UV3600, available from Shimadzu Corporation).

A state, size, or material of the light-absorbing material are not particularly limited and may be appropriately selected depending on the intended purpose.

Examples of the state of the light-absorbing material include a liquid, a solid, and a powder. Particularly, to be able to fly a highly viscous body or solid is an advantage that cannot be obtained by an inkjet recording system known in the art.

When the light-absorbing material is a solid or powder, the form of the light-absorbing material is preferably a state where the light-absorbing material has viscosity at the time when the light-absorbing material is irradiated with the optical vortex laser beam. Specifically, when a solid or powder is intended to make fly, for example, the solid or powder is preferably heated to form into a melted state to give viscosity before irradiating with the optical vortex laser beam.

The liquid light-absorbing material is not particularly limited and may be appropriately selected depending on the intended purpose. Examples thereof include an ink including a pigment and a solvent, and a conductive paste including a conductor and a solvent. When the ink including a solvent is irradiated with an optical vortex laser beam and the solvent does not absorb light, energy of the optical vortex laser beam is applied to the contents that absorb the light, other than the solvent, and the solvent is made fly together with the contents.

A viscosity of the liquid light-absorbing material is not particularly limited and may be appropriately selected depending on the intended purpose. The viscosity thereof is preferably 1 Pas or greater, and more preferably 1 Pa·s or greater but 20 Pa·s or less.

Note that, the viscosity can be measured, for example, by means of a rotational viscometer (VISCOMATE VM-150III, available from Toki Sangyo Co., Ltd.) in an environment of 25° C.

The conductive paste is not particularly limited and may be appropriately selected depending on the intended purpose, as long as the conductive paste is an ink including a conductor. Examples thereof include conductive paste known or typically used in production methods of circuit boards.

The conductor is not particularly limited and may be appropriately selected depending on the intended purpose. Examples thereof include: inorganic particles having conductivity, such as silver, gold, copper, nickel, ITO, carbon, and carbon nanotubes; and particles formed of a conductive organic polymer, such as polyaniline, polythiophene (e.g., poly(ethylenedioxythiophene)), polyacetylene, and polypyrrole. The above-listed examples may be used alone or in combination.

The volume resistivity of the conductive paste is not particularly limited and may be appropriately selected depending on the intended purpose. The volume resistivity thereof is preferably 10³ Ω·cm or less because the conductive paste can be used as a typical electrode.

Examples of the powderous light-absorbing material include metal particles, such as a toner including a pigment and a binder resin, and solder balls.

When the powderous light-absorbing material is irradiated with an optical vortex laser beam, in this case, energy of the optical vortex laser beam is applied to the pigment, and the binder resin is made fly together with the pigment as the toner. Note that, a pigment alone may be used as the powderous light-absorbing material.

The solid light-absorbing material is not particularly limited and may be appropriately selected depending on the intended purpose. Examples of the solid light-absorbing material include a metal thin film formed by sputtering or vapor deposition, and a material formed by compressing a powder, such as dispersoids.

The metal thin film is not particularly limited and may be appropriately selected depending on the intended purpose. Examples of the metal include typical metals that can be deposited through vapor deposition or sputtering, such as silver, gold, aluminium, platinum, and copper. The above-listed examples may be used alone or in combination.

Examples of the method for making the metal thin film fly to form an image pattern include a method where a metal thin film is formed on a base, such as glass and a film, in advance, and the metal thin film is irradiated with an optical vortex laser beam to make the metal thin film fly to form an image pattern. Another examples of the method include a method where non-imaging areas of the metal thin film are made fly to form an image pattern.

The material formed by compressing a powder is preferably a material in the form of a layer having a certain average thickness in a manner that the solid in the formed layer is born on a surface of the base.

A size of the light-absorbing material is not particularly limited and may be appropriately selected depending on the intended purpose.

The average thickness of the light-absorbing material is not particularly limited and may be appropriately selected depending on the intended purpose. The average thickness thereof is preferably 5 μm or greater, more preferably 10 μm or greater, and even more preferably 10 μm or greater but 50 μm or less. When the average thickness of the light-absorbing material is within the above-mentioned preferable range, scattering of the light-absorbing material can be prevented when the optical vortex laser beam is applied.

When the average thickness of the light-absorbing material is within the preferable range, in the case where the light-absorbing material is supplied in the form of a layer, the strength of the layer can be secured with continuous flying, and therefore stably supply thereof can be realized. Moreover, the energy of the optical vortex laser beam is not excessively high, and therefore deterioration or decomposition does not easily occur, particularly in the case where the light-absorbing material is an organic material.

Depending on the method for applying, the liquid colorant may be also supplied as a layer holding a certain pattern.

A measurement method of the average thickness is not particularly limited and may be appropriately selected depending on the intended purpose. Examples thereof include a method where a plurality of arbitrary points on the light-absorbing material are selected and an average of values of a thickness at the points is calculated. The average is preferably an average of thickness at 5 points, more preferably an average of thickness at 10 points, and particularly preferably an average of thickness of 20 points.

A measuring instrument of the average thickness is not particularly limited and may be appropriately selected depending on the intended purpose. Examples thereof include a method of a non-contact or contact system using a laser displacement meter or a micrometer.

A material of the light-absorbing material is not particularly limited and may be appropriately selected depending on the intended purpose. In the case where image formation is performed, for example, the material may be a colorant, such as a toner. In the case where a three-dimensional object is produced, the material may be a three-dimensional object forming agent.

### —Colorant—

Similarly to the light-absorbing material, a state, material, etc. of the colorant are not particularly limited and may be appropriately selected depending on the intended purpose. Points that are different from the above, when the light-absorbing material is a colorant, will be described hereinafter.

The liquid colorant is not particularly limited and may be appropriately selected depending on the intended purpose. For example, an aqueous ink, in which a colorant, such as a dye, a pigment, colorant particles, and colorant oil droplets, is dispersed in water, can be used.

Moreover, the liquid colorant is not limited to the aqueous ink. A colorant including, as a solvent, a liquid having a relatively low boiling point, such as hydrocarbon-based organic solvent or various alcohols, may be also used. Among the above-listed examples, an aqueous ink is preferably in view of safety of volatile components, and a low risk of explosion.

Moreover, the image forming apparatus can form an image with a process ink for offset printing using a plate, an ink corresponding to JAPAN COLOR, and an ink of special color. Therefore, a digital image corresponding to colors used in offset printing can be easily reproduced.

Moreover, an image can be also formed with a UV curable ink. UV rays are applied during the fixing step to cure the UV curable ink, and therefore blocking, which is a phenomenon where overlapped recording media are adhered to one another, is prevented, and a drying step can be simplified.

Examples of a material of the colorant include organic pigments, inorganic pigments, and dyes. The above-listed examples may be used alone or in combination.

Examples of the organic pigments include dioxazine violet, quinacridone violet, copper phthalocyanine blue, phthalocyanine green, sap green, monoazo yellow, disazo yellow, polyazo yellow, benzimidazolone yellow, isoindolinone yellow, fast yellow, cromophtal yellow, nickel azo yellow, azomethine yellow, benzimidazolone orange, alizarin red, quinacridone red, naphthol red, monoazo red, polyazo red, perylene red, anthraquinonyl red, diketo-pyrrolo-pyrrole red, diketo-pyrrolo-pyrrole orange, benzimidazolone brown, sepia, and aniline black. Examples of metal lake pigments among the organic pigments include rhodamine lake, quinoline yellow lake, and brilliant blue lake.

Examples of the inorganic pigments include cobalt blue, cerulean blue, cobalt violet, cobalt green, zinc white, titanium white, titanium yellow, chromium titanium yellow, light red, chromium oxide green, Mars black, viridian, yellow ocher, alumina white, cadmium yellow, cadmium red, vermilion, lithopone, ultramarine, talk, white carbon, clay, mineral violet, rose cobalt violet, silver white, calcium carbonate, magnesium carbonate, zinc oxide, zinc sulfide, strontium sulfide, strontium aluminate, yellow copper, gold powder, bronze powder, aluminum powder, brass pigments, ivory black, peach black, lamp black, carbon black, Prussian blue, aureolin, mica titanium, yellow ocher, terre verte, raw sienna, raw umber, cassel earth, chalk, plaster, burnt sienna, burnt umber, lapis lazuli, azulite, malachite, orpiment, cinnabar, coral powder, gofun powder, red iron oxide, ultramarine, deep blue, argentine, and iron oxide-treated pearl.

Among the above-listed examples, carbon black is preferable as a black pigment in view of hue, and image storage properties.

As a cyan pigment, C.I. Pigment Blue 15:3 that is copper phthalocyanine blue is preferable in view of hue, and image storage properties.

As a magenta pigment, C.I. Pigment Red 122 that is quinacridone red, C.I. Pigment Red 269 that is naphthol red, and C.I. Pigment Red 81:4 that is rhodamine lake are preferable. The above-listed examples may be used alone or in combination. Among the above-listed examples, a mixture of C.I. Pigment Red 122 and C.I. Pigment Red 269 is more preferable in view of hue and image storage properties. As the mixture of C.I. Pigment Red 122 (P.R.122) and C.I. Pigment Red 269 (P.R.269), a mixture thereof where P.R. 122:P.R.269 is 5:95 or greater but 80:20 or less is particularly preferable. When the ratio of P.R.122:P.R.269 is within the particularly preferable range, hue is a value within the range of magenta.

As a yellow pigment, C.I. Pigment Yellow 74 that is monoazo yellow, C.I. Pigment Yellow 155 that is disazo yellow, C.I. Pigment Yellow 180 that is benzimidazolone yellow, and C.I. Pigment Yellow 185 that is isoindolinone yellow are preferable. Among the above-listed examples, C.I. Pigment Yellow 185 is more preferable in view of hue and image storage properties. The above-listed examples may be used alone or in combination.

When the light-absorbing material is used as a process color ink serving as a colorant, the light-absorbing material is preferably used in a 4-color ink set.

The inorganic pigment is often formed of particles having the volume average particle diameter of greater than 10 μm. When the inorganic pigment having the volume average particle diameter of 10 μm or greater is used as a colorant, the colorant is preferably a liquid. Use of the liquid colorant is advantageous because the colorant is maintained in a stable state without using a force other than non-electrostatic adhesion, such as electrostatic force. In this regard, moreover, the image forming method of the present disclosure is very effective compared with an inkjet printing system that has an obvious tendency towards nozzle clogging and ink sedimentation and cannot expect a stable continuous printing process. Moreover, the image forming method of the present disclosure is very effective compared with an electrophotographic system that cannot establish a stable continuous printing process if the colorant particles have a small surface area that cannot afford a sufficient charge capacity.

Examples of the dyes include monoazo dyes, polyazo dyes, metal complexed azo-dyes, pyrazolone azo-dyes, stilbene azo-dyes, thiazole azo-dyes, anthraquinone derivatives, anthrone derivatives, indigo derivatives, thioindigo derivatives, phthalocyanine dyes, diphenyl methane dyes, triphenylmethane dyes, xanthene dyes, acridine dyes, azine dyes, oxazine dyes, thiazine dyes, polymethine dyes, azomethine dyes, quinoline dyes, nitro dyes, nitroso dyes, benzoquinone dyes, naphthoquinone dyes, naphthalimide dyes, and perinone dyes.

The viscosity of the colorant is not particularly limited and may be appropriately selected depending on the intended purpose.

In the case a liquid colorant that permeates a recording medium is used, the colorant deposited on the recording medium may cause feathering or bleeding. The colorant having high viscosity that can be handled in the image forming apparatus of the present disclosure dries faster than the permeation speed of a recording medium, and therefore coloring ability is improved and edges of an image are made sharp particularly due to reduction in bleeding. Accordingly, an image of high image quality can be formed. In the case where tone expression is performed by overlapping colorants to be deposited, moreover, bleeding due to increase in the amount of the colorant can be suppressed.

Moreover, the image forming method is intended to make the liquid colorant fly to deposit the liquid colorant. Therefore, the image forming method can excellently perform recording even when a recording medium has a minute roughness, compared with a so-called thermal transfer system that is configured to melt and transfer the colorant from a film colorant bearer with heat.

An average thickness of the colorant is not particularly limited and may be appropriately selected depending on the intended purpose. The average thickness thereof is preferably 100 μm or less. When the average thickness of the colorant is 100 μm or less, it is possible to save the energy for flying the colorant. This is advantageous in durability of the colorant bearer, and in that the composition of the colorant when the colorant is an organic substance is less likely to undergo, for example, decomposition. The preferable range of the average thickness varies depending on a recording medium for use and the intended purpose.

In the case where coat paper or a smooth film typically used for offset printing is used as a recording medium, for example, the average thickness of the colorant is preferably 0.5 μm or greater but 5 μm or less. When the average thickness thereof is within the preferable range, it is difficult for a human eye to recognize a color difference due to a minor variation in the average thickness of the recording medium. This is advantageous in that an image tends to have a high saturation even on the coat paper, and in that an image expressed tends to be clear without obvious dot gain of the halftone dots.

In the case where a recording medium having a surface roughness greater than the surface roughness of coat paper or film, such as woodfree paper for office use is used as a recording medium, for example, the average thickness of the colorant is preferably 3 μm or greater but 10 ipm or less. When the average thickness is within the preferable range, a good image quality tends to be obtained without influence from the surface roughness of the recording medium. Furthermore, particularly, when a full-color image is expressed with the colorants of the process colors, an obvious stepped difference tends not to be felt even though layers of the plurality of colorants are overlaid.

In the case where the colorant is used in textile printing in which, for example, cloth or fiber is dyed, moreover, the average thickness of the colorant is often set to 5 μm or greater in order to deposit the colorant on cotton, silk, or synthetic fiber serving as a recording medium. This is because the diameter of the fiber is greater than in paper. Therefore, in many cases, a large amount of the colorant may be used.

### <Base>

A shape, structure, size, material, etc. of the base are not particularly limited and may be appropriately selected depending on the intended purpose. The shape of the base is not particularly limited and may be appropriately selected depending on the intended purpose, as long as the base can bear the light-absorbing material on a surface thereof, and the optical vortex laser beam can be applied from a back surface thereof. Examples of the shape of the base include a flat plate shape, a cylindrical shape of a perfect circle, an oval, etc., a plane formed by cutting part of a cylindrical shape, and an endless belt shape. Among the above-listed examples, it is preferred that the base be a cylindrical shape, and a light-absorbing material supplying unit configured to supply a light-absorbing material to a surface of the base rotating in a circumferential direction be disposed. When the light-absorbing material is born on the surface of the cylindrical base, the light-absorbing material can be supplied regardless of a size of the depositing target in the circumferential direction. In this case, moreover, the light-absorbing material flying unit can be disposed inside the cylinder to apply an optical vortex laser beam from the inside to the outer circumference so that the base can be continuously irradiated by rotating the base in the circumferential direction. Moreover, examples of the shape of the planar base include a glass slide.

A structure of the base is not particularly limited and may be appropriately selected depending on the intended purpose.

A size of the base is not particularly limited and may be appropriately selected depending on the intended purpose. The size of the base is preferably a size thereof matched with a width of the depositing target.

A material of the base is not particularly limited and may be appropriately selected depending on the intended purpose, as long as the material of the base transmits light. Among materials that transmit light, inorganic materials, such as various glass including silicon oxide as a main component, and organic materials, such as transparent heat resistant plastics, and elastomers, are preferable in view of transmittance and heat resistance.

Surface roughness Ra of the base is not particularly limited and may be appropriately selected depending on the intended purpose. The surface roughness Ra of the base is preferably 1 μm or less on both the front surface and back surface thereof in order to suppress refractive scattering of an optical vortex laser beam to prevent reduction in energy applied to the light-absorbing material. When the surface roughness Ra is within the preferable range, moreover, it is advantageous because unevenness in the average thickness of the light-absorbing material deposited on the depositing target can be suppressed, and a desired amount of the light-absorbing material can be deposited.

The surface roughness Ra can be measured according to JIS B0601. For example, the surface roughness Ra can be measured by means of a confocal laser microscope (available from KEYENCE CORPORATION) or a stylus surface profiler (Dektak150, available from Bruker AXS GmbH).

### <Depositing Target>

The depositing target (transfer medium) is not particularly limited and may be appropriately selected depending on the intended purpose. Examples thereof include a recording medium for forming an image, and an object supporting substrate for forming a three-dimensional object.

### —Recording Medium—

The recording medium is not particularly limited and may be appropriately selected depending on the intended purpose. Examples of the recording medium include coat paper, woodfree paper, a film, a cloth, and fibers.

A gap between the depositing target and the light-absorbing material is not particularly limited and may be appropriately selected depending on the intended purpose, as long as the depositing target and the light-absorbing material are not in contact with each other. The gap is preferably 0.05 mm or greater but 5 mm or less, more preferably 0.10 mm or greater but 1 mm or less, and particularly preferably 0.10 mm or greater but 0.50 mm or less. When the gap between the depositing target and the light-absorbing material is within the preferable range, it is advantageous because precision of the deposition position of the light-absorbing material to the depositing target is easily maintained. Since the depositing target and the light-absorbing material are not brought into contact with each other, moreover, the light-absorbing material can be deposited on the depositing target regardless of compositions of the light-absorbing material and the depositing target.

Moreover, the gap is preferably maintained constant, for example, by a position controlling unit configured to maintain a position of a depositing target constant. In this case, it is important to arrange each unit considering variations in the positions of the light-absorbing material and the depositing target, and the variations in the average thickness.

Moreover, the average diameter of the light-absorbing material (average dot diameter) on the transfer medium (depositing target) after transferring (deposition) is not particularly limited and may be appropriately selected depending on the intended purpose. The average diameter thereof is preferably 100 μm or less, because resolution of an image or three-dimensional object formed can be improved. In the present disclosure, the diameter of the liquid droplet flown is smaller than the diameter of the emitted optical vortex laser beam during flying. A diameter of a dot formed on the transfer medium however changes depending on a relationship between impact at the time when the liquid droplet lands and surface tension with a surface of the transfer medium.

Moreover, the average dot diameter can be determined, for example, by obtaining a dot image of the light-absorbing material by a microscope etc. to detect a dot region from image brightness information, calculating an area of each dot from the number of pixels in the detected dot region, determining a diameter of a circle converted from the area as a dot diameter, and calculating an average of the dot diameters.

Moreover, dispersion value of the diameter of the light-absorbing material (dot diameter) on the transfer medium (depositing target) after transferring (deposition) is preferably 10% or less, and more preferably 6% or less. When the dispersion value of the diameter of the light-absorbing material on the transfer medium after transferring is within the above-mentioned preferable range, precision for forming an image or a three-dimensional object can be further improved.

The dispersion value of the diameter of the light-absorbing material on the transfer medium after transferring can be determined, for example, by obtaining a dot image of the light-absorbing material by a microscope etc., to detect the dot region from the image brightness information, calculating an area of each dot from the number of pixels in the detected dot region, determining a diameter of a circle converted from the area as a dot diameter, and calculating the dispersion from the average particle diameter of the particle size distribution of each dot and standard deviation.

In addition, the dispersion value of the position of the light-absorbing material (dot position) on the transfer medium (depositing target) after transferring (deposition) is preferably 10 μm or less, and more preferably 5 μm or less. When the dispersion value of the position of the light-absorbing material on the transfer medium after transferring is within the above-mentioned preferable range, precision for forming an image or a three-dimensional object can be further improved. Note that, the dispersion value of the position of the light-absorbing material on the transfer medium after transferring is a dispersion value of the position of the light-absorbing material in the direction orthogonal to an array of the dots, for example, when the dots of the light-absorbing material are deposited in the array.

The dispersion value of the dot position can be determined, for example, by obtaining a dot image of the light-absorbing material by a microscope etc. to detect a dot region from image brightness information, calculating barycentric coordinates of each dot region detected, and calculating displacement from the approximate straight line of each barycenter according to the least squares method.

Note that, the light-absorbing material flying unit, the light-absorbing material supplying unit, and the beam scanning unit may be handled as a colorant flying unit.

For example, four colorant flying units are disposed in the image forming apparatus to make colorants of yellow, magenta, cyan, and black, which are process colors, fly. The number of colors of the colorants is not particularly limited and may be appropriately selected depending on the intended purpose. The number of the colorant flying units may be increased or decreased according to the necessity. Moreover, a white concealing layer can be disposed by arranging the colorant flying unit including a white colorant upstream of the colorant flying units including the colorants of process colors in the transporting direction of a recording medium. Therefore, an image having excellent color reproducibility can be formed on a transparent recording medium. Especially with the colorant of yellow, white, or transparent, a laser light source, such as laser light sources of a blue laser beam and a UV laser beam, may be appropriately selected in order to obtain appropriate transmittivity (absorbance) to a wavelength of an optical vortex laser beam.

Since the image forming apparatus can use a colorant having high viscosity, moreover, occurrences of bleeding caused by bleeding and mixing of the colorants can be suppressed even when colorants of different colors are overlapped to form an image on a recording medium. Therefore, a color image having high image quality can be obtained.

For the purpose of down-sizing of the image forming apparatus, an image of a plurality of colors may be formed by disposing only one colorant flying unit, and replacing the colorant itself to be supplied to a supply roller and a colorant bearer.

Moreover, the image forming apparatus of the present disclosure may be also applied as a production device of a three-dimensional object as described below.

### (Production Device of Three-Dimensional Object)

The production device of a three-dimensional object includes at least a three-dimensional object forming agent flying device, preferably further includes a three-dimensional object forming agent curing unit, and may further include other units according to the necessity. The three-dimensional object forming agent flying device is the image forming apparatus where the light-absorbing material is a three-dimensional object forming agent, and the three-dimensional object forming agent is made fly by the three-dimensional object forming agent flying unit.

### <Three-Dimensional Object Forming Agent Flying Unit>

The three-dimensional object forming agent flying unit is identical to the above-described light-absorbing material flying unit, with the proviso that the light-absorbing material is a three-dimensional object forming agent and the depositing target is an object supporting substrate. Therefore, descriptions thereof are omitted. Note that, the three-dimensional object forming agent flying unit is configured to overlap the three-dimensional object forming agent as layers and three-dimensionally deposit the three-dimensional object forming agent on the object supporting substrate.

### <Three-Dimensional Object Forming Agent Curing Unit>

The three-dimensional object forming agent curing unit is not particularly limited and may be appropriately selected depending on the intended purpose. Examples thereof include a UV irradiator when the three-dimensional object forming agent is a UV curable material.

The three-dimensional object forming agent curing step is not particularly limited and may be appropriately selected depending on the intended purpose. Examples thereof include a UV irradiating step when the three-dimensional object forming agent is a UV curable material. The three-dimensional object forming agent curing step can be suitably performed by the three-dimensional object forming agent curing unit.

### <Other Units>

Examples of other units include a three-dimensional object forming agent supplying unit, a three-dimensional object head unit scanning unit, a substrate position adjusting unit, and a controlling unit.

### <<Three-Dimensional Object Forming Agent Supplying Unit>>

The three-dimensional object forming agent supplying unit is identical to the above-described light-absorbing material supplying unit, with the proviso that the light-absorbing material is the three-dimensional object forming agent, and the depositing target is the object supporting substrate. Therefore, descriptions thereof are omitted.

### <<Three-Dimensional Object Forming Head Unit Scanning Unit>>

The three-dimensional object forming head unit scanning unit is not particularly limited and may be appropriately selected depending on the intended purpose. For example, a three-dimensional object forming head unit, in which the light-absorbing body flying unit and a UV ray light-absorbing material flying unit are integratedly mounted, may be scanned along a width direction (X axis) of the device above the object supporting substrate. Note that, the three-dimensional object forming heat unit is, for example, configured to cure the three-dimensional object forming agent deposited by the light-absorbing body flying unit using the UV ray light-absorbing material flying unit. Moreover, a plurality of the three-dimensional object forming head units may be disposed.

### <<Substrate Position Adjusting Unit>>

The substrate position adjusting unit is not particularly limited and may be appropriately selected depending on the intended purpose. For example, the substrate position adjusting unit may be a base (stage) that can adjust a position of the object supporting substrate in a depth direction (Y axis) and height direction (Z axis) of the device.

### <<Controlling Unit>>

The controlling unit is identical to the above-described controlling unit of the image forming apparatus. Therefore, descriptions thereof are omitted.

### <Three-Dimensional Object Forming Agent>

Similarly to the light-absorbing material, a shape, material, etc. of the three-dimensional object forming agent are not particularly limited and may be appropriately selected depending on the intended purpose. Only different points when the light-absorbing material is the three-dimensional object forming agent will be described hereinafter.

The average thickness of the three-dimensional object forming agent is not particularly limited and may be appropriately selected depending on the intended purpose. The average thickness thereof is preferably 5 μm or greater but 500 μm or less although the preferable average thickness varies depending on precision desired. The average thickness being within the above-mentioned preferable range is advantageous in view of precision, smoothness, and production time of a three-dimensional object. Moreover, the average thickness of the three-dimensional object forming agent is more preferably 5 μm or greater but 100 μm or less. When the average thickness thereof is within the more preferable range, it is advantageous because energy of an optical vortex laser beam can be kept low, and deterioration of the three-dimensional object forming agent is prevented.

The three-dimensional object forming agent includes at least a curing material, and may further include other components according to the necessity.

### <<Curing Material>>

The curing material is not particularly limited and may be appropriately selected depending on the intended purpose, as long as the curing material is a compound that induces a polymerization reaction upon application of active energy rays (e.g., UV rays and electron beams), heat, etc. to be cured. Examples thereof include an active energy ray curable compound, and a heat curable compound. Among the above-listed examples, a material that is a liquid at room temperature is preferable.

The active energy ray curable compound is a monomer that has a radically polymerizable unsaturated double bond in a molecular structure thereof and has a relatively low viscosity. Examples thereof include monofunctional monomers and polyfunctional monomers.

### <<Other Components>>

Other components are not particularly limited and may be appropriately selected depending on the intended purpose. Examples thereof include water, an organic solvent, a photopolymerization initiator, surfactant, a colorant, a stabilizer, a water-soluble resin, low-boiling point alcohol, a surface treating agent, a viscosity modifier, a tackifier, an antioxidant, an age resister, a cross-linking accelerator, an ultraviolet absorber, a plasticizer, an antiseptic, and a dispersant.

### <Three-Dimensional Object Forming Agent Bearer>

The three-dimensional object forming agent bearer is identical to the above-described base, with the proviso that the light-absorbing material is the three-dimensional object forming agent. Therefore, descriptions thereof are omitted.

### <Object Supporting Substrate>

The object supporting substrate is not particularly limited and may be appropriately selected depending on the intended purpose. For example, the positions of the object supporting substrate on the Y axis and the Z axis may be adjusted by the substrate position adjusting unit.

A gap between the object supporting substrate and the three-dimensional object forming agent bearer is identical to the gap between the depositing target and the base. Therefore, descriptions thereof are omitted.

Next, examples of the image forming apparatus of the present disclosure will be described with reference of drawings.

Note that, the number, position, shape, etc. of the constitutional member below is not limited to the present embodiments, and may be changed to the preferably number, position, shape, etc. for carrying out the present disclosure.

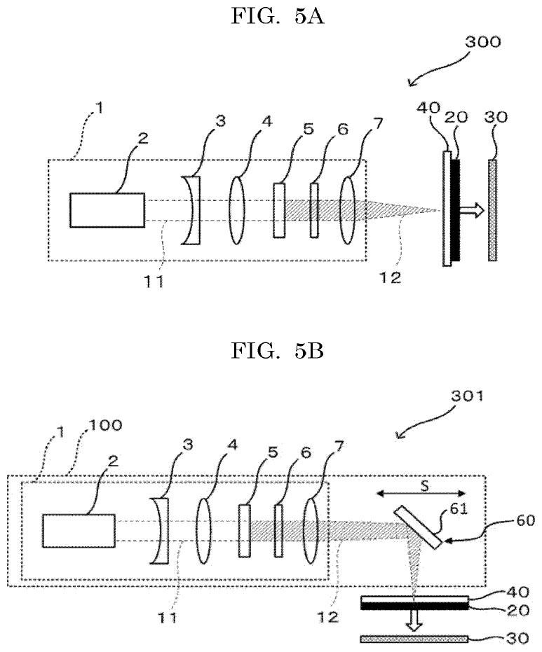

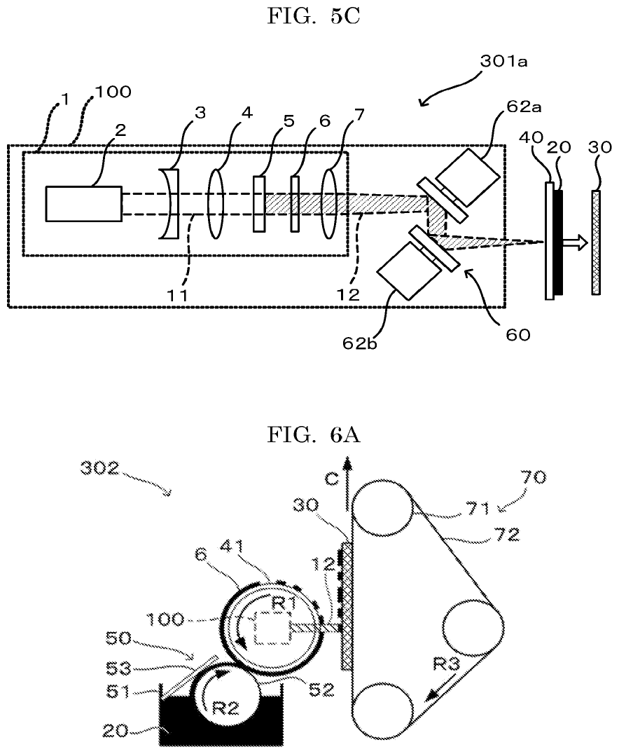

FIG. 5A is an explanatory view illustrating one example of the image forming apparatus of the present disclosure.

In FIG. 5A, an image forming apparatus 300 includes a light-absorbing material flying unit 1, a light-absorbing material 20 that absorbs light, a depositing target 30, and a base 40. The image forming apparatus 300 is an apparatus configured to irradiate the light-absorbing material 20 born on the base 40 with an optical vortex laser beam 12 emitted from the light-absorbing material flying unit 1 to make the light-absorbing material 20 fly in the irradiation direction with the energy of the optical vortex laser beam 12, to thereby deposit the light-absorbing material 20 on the depositing target 30.

The light-absorbing material flying unit 1 includes a laser light source 2, beam diameter changing members 3 and 7, a beam wavelength changing member 4, an optical vortex converting unit 5, and a wavelength converting unit 6.

The laser light source 2 is, for example, a titanium-sapphire laser, and is configured to generate a pulse oscillated laser beam 11 to irradiate the beam diameter changing member 3 with the laser beam 11.

For example, the beam diameter changing member 3 is a condenser lens, is disposed downstream of the laser light source 2 on the light path of the laser beam 11 generated by the laser light source 2, and is configured to change a diameter of the laser beam 11.

The beam wavelength changing member 4 is, for example, a KTP crystal, is disposed downstream of the beam diameter changing member 3 on the light path of the laser beam 11, and is configured to change the wavelength of the laser beam 11 to a wavelength thereof that can be absorbed by the light-absorbing material 20.

The optical vortex converting unit 5 is, for example, a spiral phase plate, is disposed downstream of the beam wavelength changing member 4 on the light path of the laser beam 11, and is configured to convert the laser beam 11 into an optical vortex laser beam 12.

The wavelength converting unit 6 is, for example, a quarter wave plate, and is configured to give circular polarization to the optical vortex laser beam.

The light-absorbing material 20 is irradiated with the optical vortex laser mean 12 emitted from the light-absorbing material flying unit 1, receives the energy in the range of the diameter of the optical vortex laser beam 12 to fly and is then deposited on the depositing target 30.

The flown light-absorbing material 20 is deposited on the depositing target 30 while scattering of the light-absorbing material 20 to the surrounding is suppressed by twisting by a forward movement by appropriate energy and a gyro effect imparted by the optical vortex laser beam 12 with converging on around a central axis of the beam diameter.

Here, the flying amount of the light-absorbing material 20 to fly corresponds to a part or the whole of the area of the light-absorbing material 20 irradiated with the optical vortex laser beam 12, and can be adjusted by, for example, the wavelength converting unit 6.

FIG. 5B is an explanatory view illustrating another example of the image forming apparatus of the present disclosure.

In FIG. 5B, in addition to each of the units of the image forming apparatus 300 illustrated in FIG. 5A, the image forming apparatus 301 includes a base 40, and a beam scanning unit 60. The image forming apparatus 301 is configured to scan the optical vortex laser beam 12 generated by the light-absorbing material flying unit 1 in a direction perpendicular to the irradiation direction of the optical vortex laser beam 12 using the beam scanning unit 60. As a result, the image forming apparatus 301 can deposit, on the depositing target 30, the light-absorbing material 20 flown by irradiating the predetermined position of the light-absorbing material 20 born on the planar base 40.

The beam scanning unit 60 is disposed downstream of the light-absorbing material flying unit 1 on the light path of the optical vortex laser beam 12, and includes a reflector 61.

The reflector 61 is movable in the scanning direction indicated with the arrow S in FIG. 5B by a reflector driving unit, and is configured to reflect the optical vortex laser beam 12 to the predetermined position of the light-absorbing material 20.

The beam scanning unit 60 may be, for example, configured to move the light-absorbing material flying unit 1 itself, or to rotate the light-absorbing material flying unit 1 to change the irradiation direction of the optical vortex laser beam 12. Alternatively, the beam scanning unit 60 may be configured to scan the optical vortex laser beam 12 to the predetermined position using a polygon mirror as the reflector 61.

The base 40 is disposed downstream of the beam scanning unit 60 on the light path of the optical vortex laser beam 12. In the case where the light-absorbing material 20 is a high viscous liquid, for example, the base 40 is used for the purpose of applying and fixing the light-absorbing material 20 thereon. The base 40 can transmit light, and bears the light-absorbing material 20 on the surface thereof. The liquid-absorbing material 20 is irradiated with the optical vortex laser beam 12 from the back surface of the base 40.

Moreover, the flying amount of the light-absorbing material 20 can be stabilized by controlling the average thickness of the light-absorbing material 20 formed into a layer to be constant when the light-absorbing material 20 is applied to be born on the base 40.

Note that, a combination of the light-absorbing material flying unit 1 and the beam scanning unit 60 is referred to as an optical vortex laser beam irradiation unit 100.

FIG. 5C is an explanatory view illustrating another example of the image forming apparatus of the present disclosure.

In FIG. 5C, the image forming apparatus 301a includes galvanometer scanners (galvanometer mirrors) 62a and 62b as the beam scanning unit 60 of the image forming apparatus 301 illustrated in FIG. 5B. The galvanometer scanners 62a and 62b are each independently movable in the scanning direction (two-dimensional), and are configured to reflect the optical vortex laser beam 12 to the predetermined position of the light-absorbing material 20. The scanning speed and scanning precision of the optical vortex laser beam 12 can be improved by using the galvanometer scanners 62a and 62b as the beam scanning unit 60.

Moreover, an fθ lens is preferably disposed, for example, between the galvanometer scanner 62b and the base 40 in the image forming apparatus 301a.

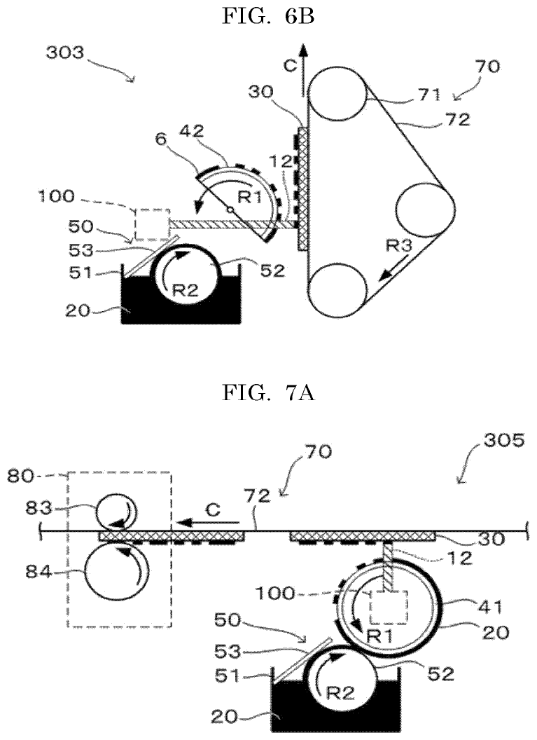

FIG. 6A is an explanatory view illustrating one example of the image forming apparatus illustrated in FIG. 5B, to which a light-absorbing material supplying unit and a depositing target transporting unit are added.

In FIG. 6A, in addition to the units of the image forming apparatus 301 illustrated in FIG. 5B, the image forming apparatus 302 includes a light-absorbing material supplying unit 50 and a depositing target transporting unit 70, where the planar base 40 of FIG. 5B is replaced with a cylindrical light-absorbing material bearing roller 41. Moreover, the optical vortex laser beam irradiation unit 100 is disposed inside the light-absorbing material bearing roller 41, and is configured to irradiate the depositing target 30 born on the outer circumference of the light-absorbing material bearing roller 41 with the optical vortex laser beam 12.

The light-absorbing material supplying unit 50 includes a storage tank 51, a supply roller 52, and a regulating blade 53.

The storage tank 51 is disposed in the lower adjacency of the supply roller 52, and is configured to store the light-absorbing material 10.

The supply roller 52 is disposed to be in contact with the light-absorbing material bearing roller 41, and part of the supply roller 52 is dipped in the light-absorbing material 10 in the storage tank 51. The supply roller 52 is configured to rotate in the rotational direction indicated with the arrow R2 in FIG. 6A by a rotation driving unit, or following the rotation of the light-absorbing material bearing roller 41, to thereby deposit the light-absorbing material 10 on a surface of the supply roller. The average thickness of the deposited light-absorbing material 10 is leveled by the regulating blade 53, and the light-absorbing material 10 is supplied as a layer by transferring to the light-absorbing material bearing roller 41. The light-absorbing material 10 supplied onto the surface of the light-absorbing material bearing roller 41 is continuously supplied to the position to which the optical vortex laser beam 12 is applied by rotating the light-absorbing material bearing roller 41.

The regulating blade 53 is disposed upstream of the light-absorbing material bearing roller 41 in the rotational direction indicated with the arrow R2 in FIG. 6A, and is configured to regulate the light-absorbing material 10 deposited on the surface by the supply roller 52 to level the average thickness of the light-absorbing material 10 supplied to the light-absorbing material bearing roller 41.

The depositing target transporting unit 70 is disposed adjacent to the light-absorbing material bearing roller 41 in the manner that the light-absorbing material bearing roller 41 and the depositing target 30 to be transported do not come into contact with each other. The depositing target transporting unit 70 includes a depositing target transporting roller 71, and a depositing target transporting belt 72 supported by the depositing target transporting roller 71. The depositing target transporting unit 70 is configured to rotate the depositing target transporting roller 71 using a rotation driving unit to transport the depositing target 30 in the transporting direction indicated with the arrow C in FIG. 6A by the depositing target conveying belt 72.

The optical vortex laser beam irradiation unit 100 is configured to emit the optical vortex laser beam 12 according to image information from inside of the light-absorbing material bearing roller 41 to deposit the light-absorbing material 20 on the depositing target 30. The deposition operation where the light-absorbing material 20 is deposited on the depositing target 30 in the above-described manner with moving the depositing target 30 by the depositing target transporting belt 72 is performed to thereby form a two-dimensional image on the depositing target 30.

The light-absorbing material 20 born on the surface of the light-absorbing material bearing roller 41 but not made fly is accumulated as the light-absorbing material bearing roller 41 rotates to be in contact with the supply roller 52, and is eventually dropped and collected in the storage tank 51. The method for collecting the light-absorbing material is not limited to the method as described. A scraper configured to scrape the light-absorbing material 20 on the surface of the light-absorbing material bearing roller 41 may be disposed.

FIG. 6B is an explanatory view illustrating another example of the image forming apparatus illustrated in FIG. 5B, to which a light-absorbing material supplying unit and a depositing target transporting unit are added.

In FIG. 6B, the image forming apparatus 303 is identical to the image forming apparatus 302 illustrated in FIG. 6A with the proviso that the cylindrical light-absorbing material bearing roller 41 in the image forming apparatus 302 illustrated in FIG. 6A is changed to a light-absorbing material bearing unit 42 that is divided in to 2 along the axial direction to change the arrangement of the image forming apparatus 302.

The light-absorbing material bearing unit 42 has a shape that is defined by a partial surface of a cylindrical shape and has no surface on the opposite side with respect to the center line of the cylinder. Such a bearing member having no opposite surface can simplify the apparatus because a light path of the optical vortex laser beam 12 can be secured without arranging the optical vortex laser beam irradiate unit 100 in the cylindrical light-absorbing material bearing roller 41.

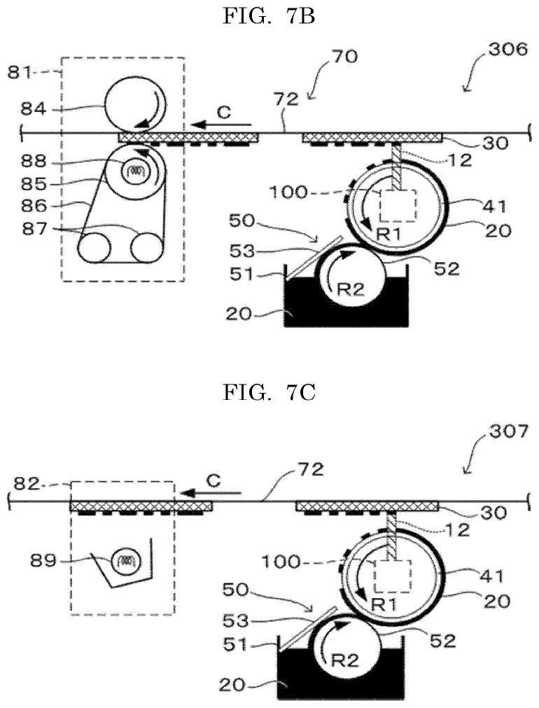

FIG. 7A is an explanatory view illustrating one example of the image forming apparatus illustrated in FIG. 6A, to which the fixing unit is added.

In FIG. 7A, the image forming apparatus 305 includes a fixing unit 80 in addition to the units of the image forming apparatus 302 illustrated in FIG. 6A, and is configured to fix the light-absorbing material deposited on the depositing target 30 to make the deposited light-absorbing material 20 smooth. The position of the depositing target transporting unit 70 is the side surface of the light-absorbing material bearing roller 41 in FIG. 6A. For convenience, the position of the depositing target transporting unit 70 is set to the upper part of the light-absorbing material bearing roller 41 in FIG. 7A.

The fixing unit 80 is a fixing unit of a press system, is disposed downstream of the light-absorbing material bearing roller 41 in the transporting direction of the depositing target 30 indicated with the arrow C in FIG. 7A, and includes a press roller 83 and a counter roller 84. The fixing unit 80 is configured to press and fix the light-absorbing material 20 by transporting the depositing target 30 on which the light-absorbing material 20 is deposited with nipping the depositing target 30.

The press roller 83 is pressed against the counter roller 84, a surface of the press roller 83 is in contact with the depositing target 30, and is configured to press the depositing target 30 with nipping the depositing target 30 between the press roller 83 and the counter roller 84.

The counter roller 84 is disposed at the position at which the counter roller 84 is in contact with the press roller 83, and the counter roller 84 nips the depositing target 30 with the press roller 83 via the depositing target transporting belt 72.

When the image forming apparatus is the image forming apparatus 305 and the light-absorbing material 20 of extremely high viscosity having the viscosity of 1,000 mPa·s or greater is used, permeation or wetting of the light-absorbing material 20 to the depositing target 30 tends to be slow. If the light-absorbing material 20 is dried as it is, the surface roughness of the image is rough, and glossiness of the image tends to be low. In such a case, the fixing unit 80 can press the depositing target 30 on which the light-absorbing material 20 is deposited to push the light-absorbing material 20 into the depositing target 30 or to crush the light-absorbing material 20. Therefore, the surface roughness of the depositing target 30 on which the light-absorbing material 20 can be made low.

FIG. 7B is an explanatory view illustrating another example of the image forming apparatus illustrated in FIG. 6A to which a fixing unit is added.

In FIG. 7B, the image forming apparatus 306 is identical to the image forming apparatus 305 illustrated in FIG. 7A, with the proviso that the fixing unit 80 of the press system is changed to a fixing unit 81 of a heat press system.

The fixing unit 81 is disposed downstream of the light-absorbing material bearing roller 41 in the transporting direction of the depositing target 30 indicated with the arrow C in FIG. 7B, and includes a heat press roller 85, a fixing belt 86, a driven roller 87, a halogen lamp 88, and a counter roller 84. The fixing unit 81 is used when a target image cannot be obtained only by heating, in the case where a dispersion liquid in which a material to be melted is dispersed is used as the light-absorbing material 20.

The heat press roller 85 is pressed against the counter roller 84, and is configured to heat and press the depositing target 30 with nipping the depositing target 30 with the counter roller 84 via the fixing belt 86.

The fixing belt 86 is an endless belt, and is supported by the heat press roller 85 and the driven roller 87. The surface of the fixing belt 86 is in contact with the depositing target 30.

The driven roller 87 is disposed below the heat press roller 85, and is driven following the rotation of the heat press roller 85.

The halogen lamp 88 is disposed inside the heat press roller 85, and is configured to generate heat for fixing the light-absorbing material on the depositing target 30.

The counter roller 84 is disposed at the position at which the counter roller 84 is in contact with the fixing belt 86, and nips the depositing target 30 with the press roller 83 via the depositing target transporting belt 72.

FIG. 7C is an explanatory view illustrating another example of the image forming apparatus illustrated in FIG. 6A to which a fixing unit is added.

In FIG. 7C, the image forming apparatus 307 is identical to the image forming apparatus 305 illustrated in FIG. 7A, with the proviso that the fixing unit 80 of the press system is changed to a fixing unit 82 of an UV irradiation system.

The fixing unit 82 is disposed downstream of the light-absorbing material bearing roller 41 in the transporting direction of the depositing target 30 indicated with the arrow C in FIG. 7C, and includes a UV lamp 89. The fixing unit 81 is used when a UV ray curable material is used as the light-absorbing material 20. The light-absorbing material 20 is fixed on the depositing target 30 by irradiating the light-absorbing material 20 with UV using the UV lamp 89.

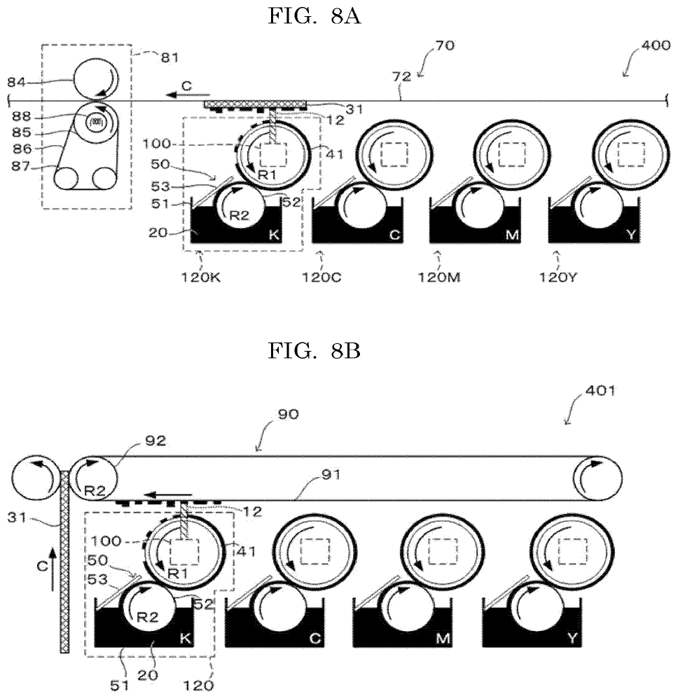

FIG. 8A is an explanatory view illustrating one example of the image forming apparatus of the present disclosure.

In FIG. 8A, the image forming apparatus 200 includes three light-absorbing body flying units 120 in addition to the units of the image forming apparatus 306 illustrated in FIG. 7B, and the light-absorbing material 20 is changed to a colorant 21.

Moreover, the light-absorbing body flying unit 120 includes a light-absorbing material supplying unit 50, a light-absorbing material flying unit 1, a beam scanning unit 60, a light-absorbing material bearing roller 41, and a light-absorbing material 20.

The light-absorbing body flying units 120Y, M, C, and K store therein, as colorants 21, toners of 4 colors, i.e., yellow (Y), magenta (M), cyan (C), and black (K) that are process colors, respectively.

Owing to the configuration of the image forming apparatus described above, the image forming apparatus can be applied for a color process where images of 4 colors are sequentially formed on the recording medium 31 to form a color image.

FIG. 8B is an explanatory view illustrating another example of the image forming apparatus of the present disclosure.

In FIG. 8B, the image forming apparatus 201 includes an intermediate transferring unit 90 as the transferring unit, in addition to the units of the image forming apparatus 200 illustrated in FIG. 8A.

The intermediate transferring unit 90 includes an intermediate transfer member 91, an intermediate transfer member driving roller 92, and an intermediate transfer member driven roller 93.

The intermediate transfer member 91 is, for example, an endless belt, is disposed at the upper area of the four light-absorbing body flying units 120, and is supported by the intermediate transfer driving roller 92, and the intermediate transfer member idle driven roller 93.

The intermediate transfer member driving roller 92 is rotated in the rotational direction indicated with the arrow R2 in FIG. 8B by the rotation driving unit to rotate the intermediate transfer member 91.

The intermediate transfer member driven roller 93 is rotated by following the rotation of the intermediate transfer member driving roller 92.

In the manner as described above, an image may be formed on the intermediate transfer member 91 first, and then the image may be transferred to a desired recording medium 31. Similarly to the image forming apparatus 200, the image forming apparatus 201 can form a color image of high image quality. Since the image is pressed by the intermediate transfer member driving roller 92 when the image formed on the intermediate transfer member 91 is transferred to the recording medium 31, surface roughness of the colorant 21 deposited on the recording medium 31 can be made small similarly to the image forming apparatus 200.

Although the irradiation direction of the optical vortex laser beam is the direction of gravity in FIG. 5B, the irradiation direction of the optical vortex laser beam is the reverse direction of the gravitational direction or the horizontal direction in FIGS. 5A and 6A to 8B.

As described above, according to the image forming method of the present disclosure, the irradiation direction of the optical vortex laser beam to the surface of the base may be a nongravitational direction to generate a liquid column or liquid droplet in the nongravitational direction. Owing to the configuration as mentioned, the degree of freedom in designing the apparatus can be increased.

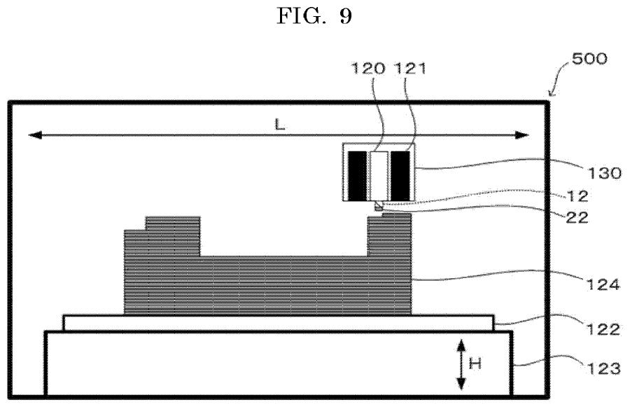

FIG. 9 is an explanatory view illustrating one example of the production device of a three-dimensional object of the present disclosure.

In FIG. 9, the production device of a three-dimensional object 500 includes an object supporting substrate 122, a stage 123, and a three-dimensional object forming head unit 130. The production device of a three-dimensional object 500 is configured to laminate the deposited three-dimensional object forming agent 22 with curing to produce a three-dimensional object 124.

The three-dimensional object forming head unit 130 is disposed at the upper area of the production device of a three-dimensional object 500, and can be scanned in the direction indicated with the arrow L in FIG. 9 by the driving unit. The three-dimensional object forming head unit 130 include a light-absorbing body flying unit 120, and a UV ray emitter 121.

The light-absorbing body flying unit 120 is disposed at a center of the three-dimensional object forming head unit 130, and is configured to make the light-absorbing body 20 fly downwards to deposit on the object supporting substrate 122 or the light-absorbing body 20 that has been already cured.

The UV emitters 121 are disposed on the both sides of the light-absorbing body flying unit 120, and are configured to emit UV rays towards the light-absorbing body 20 flown by the light-absorbing body flying unit 120 to cure the light-absorbing body 20.

The object supporting substrate 122 is disposed at the bottom area of the production device of a three-dimensional object 500, and serves as a substrate when the three-dimensional object forming head unit 130 forms a layer of the three-dimensional object forming agent 22.

The stage 123 is disposed below the object supporting substrate 122, and is capable of move the object supporting substrate 122 in the vertical direction in FIG. 9 using a driving unit. Moreover, the stage 123 can be moved in the direction indicated with the arrow H in FIG. 9 to adjust the gap between the three-dimensional object forming heat unit 130 and the three-dimensional object 124.

The examples of the image forming apparatus and the production device of a three-dimensional object where the depositing target, recording medium, and object supporting substrate are transported or moved have been described above. However, the image forming apparatus and the production device of a three-dimensional object are not limited to the examples above. The light-absorbing material flying unit etc. may be moved with keeping the depositing target still. Alternatively, both the depositing target etc., and the light-absorbing material flying unit etc. may be moved.

In the case where an image on an entire surface of a recording medium is formed at the same time, moreover, only a laser may be operated with keeping the both still at least during recording.

### EXAMPLES

The present disclosure will be described more specifically below by way of Examples. The present disclosure should not be construed as being limited to these Examples.

Examples and Comparative Examples where an UV ink serving as a light-absorbing material is irradiated with a pulse-oscillated optical vortex laser beam using the light-absorbing material flying unit illustrated in FIG. 5B to deposit the UV ink to form dots on a depositing target are described hereinafter.

### Example 1

### <Base, Light-Absorbing Material, and Depositing Target>

A UV ink having the following composition serving as a light-absorbing material was applied onto a surface of a glass slide (Microslide Glass S7213, available from Matsunami Glass Ind., Ltd., transmittivity to light having a wavelength of 532 nm: 99%) serving as a base to form a film having an average thickness of 20 μm. The transmittivity of the light-absorbing material in the form of the film to light having a wavelength of 532 nm was 0.01% or less (absorbance was 4 or greater). Moreover, the viscosity of the UV ink was measured by means of a rotational viscometer (VISCOMATE VM-150III, available from Toki Sangyo Co., Ltd.) in the environment of 25° C. and the result was 4 Pa·s.

UV Core TYPE-A Beni (available from T & K TOKA Corporation): 100 parts by mass
UV Flexo 500 Beni (available from T & K TOKA Corporation): 50 parts by mass

Next, the base was set in a manner that the surface of the base, on which the light-absorbing material had been applied, faced the depositing target, and an optical vortex laser beam was vertically applied from the back surface of the light-absorbing material.

POD gloss coat paper (available from Mitsubishi Paper Mills Limited) was used as the depositing target. The gap between the depositing target and the light-absorbing material was 1.5 mm.

### <Light-Absorbing Material Flying Unit>

The light-absorbing material flying unit included a laser light source, a beam diameter changing member, a beam wavelength changing element, a spiral phase plate serving as an optical vortex converting unit, and a quarter wave plate serving as a wavelength converting unit.

As the laser light source, a laser light source (YAG) self-made by Chiba University, Graduate School of Advanced Integration Science, Omatsu Laboratory was used, and 1 pulse of laser beam having a wavelength of 532 nm, a beam diameter of 1.25 mm×1.23 mm, a pulse width of 2 nanoseconds, and a pulse frequency of 20 Hz was generated. The generated 1 pulse of the laser beam was applied to a condenser lens (YAG laser condenser lens, available from Sigma Koki Co., Ltd.) serving as a beam diameter changing member to make a beam diameter of the laser beam Φ80 μm when the light-absorbing material was irradiated. Next, the laser beam passed the beam diameter changing member was passed through a spiral phase plate (Vortex Phase Plate, available from Luminex Trading, Inc.) to convert into an optical vortex laser beam. Next, the optical vortex laser beam converted by the spiral phase plate was passed through a quarter wave plate (QWP, available from Kogakugiken Corp.) disposed downstream of the spiral phase plate. The optical axis of the spiral phase plate and the optical axis of the quarter wave plate were set to +45° so that the total torque J represented by the formula (1) described above was to be 2. The converted optical vortex laser beam was passed through an energy adjusting filter (ND filter, available from Sigma Koki Co., Ltd.) to adjust an output of the laser to 50 μJ/dot when the laser beam was applied to the light-absorbing material.

### <Evaluation of Flying State>

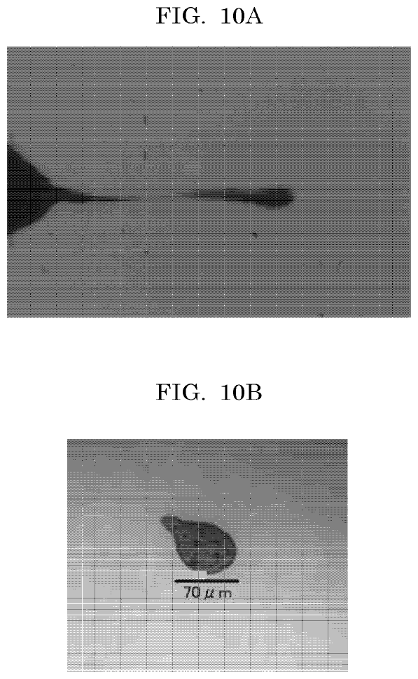

The flying state when the UV ink serving as the light-absorbing material was irradiated with the optical vortex laser beam as described above was shoot by means of a high-speed digital camera (HyperVision HPV-X, available from Shimadzu Corporation) from the direction perpendicular to the flying direction of the light-absorbing material at 100 ns per frame, and the result was evaluated based on the following criteria. The flying state is depicted in FIG. 10A and the result is presented in Table 1.

### [Evaluation Criteria]

Good: The UV ink was converged on the axis of the light path of the laser beam and moved straight ahead.
Fair: The UV ink was converged on the axis of the light path of the laser beam, but the straight movement was slightly disturbed.
Poor: The UV ink flew with scattering equal to or greater than the laser beam diameter.

### <Evaluation of Deposited State>

The deposited state of the flown light-absorbing material deposited on the depositing target was evaluated based on the following criteria. The deposited state is depicted in FIG. 10B and the result is presented in Table 1. The evaluation result of “Good” or “Fair” is a level at which there is no problem on practical use.

### [Evaluation Criteria]

Good: No scattering.
Fair: There was slight scattering.
Poor: There was scattering.

### Example 2

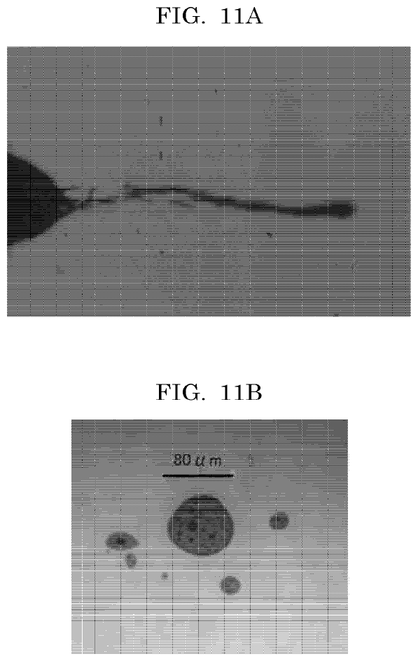

The flying state and deposited state were evaluated in the same manner as in Example 1, except that the energy adjusting filter was set in a manner that the irradiation energy when the light-absorbing material was irradiated with the optical vortex laser beam was changed from 50 μJ/dot to 60 μJ/dot. The results are presented in Table 1. Note that, the flying state is depicted in FIG. 11A and the deposited state is depicted in FIG. 11B.

### Example 3

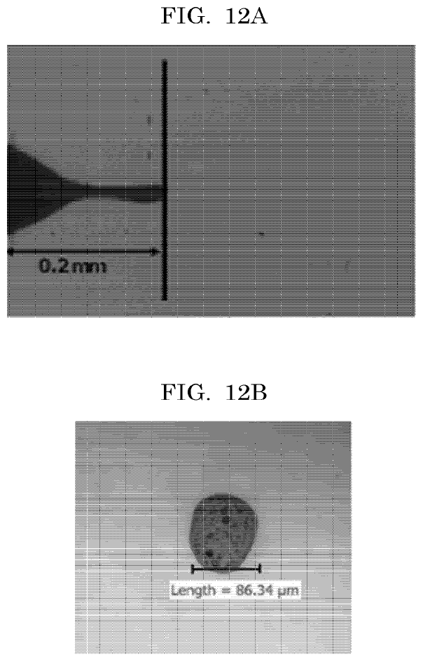

The flying state and deposited state were evaluated in the same manner as in Example 1, except that the gap between the depositing target and the light-absorbing material was changed from 1.5 mm to 0.2 mm. The results are presented in Table 1. The flying state is depicted in FIG. 12A and the deposited state is depicted in FIG. 12B. It was found that, as depicted in FIG. 12A, the UV ink film irradiated with the optical vortex laser beam was brought into the depositing target before being cut and separated, followed by cutting and separating the UV ink film.

### Example 4

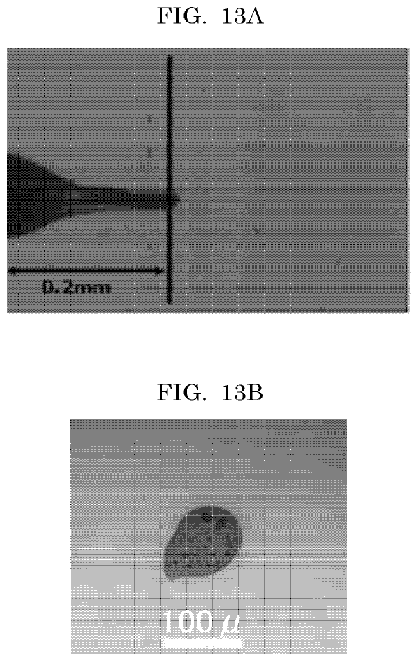

The flying state and deposited state were evaluated in the same manner as in Example 3, except that the energy adjusting filter was set in a manner that the irradiation energy when the light-absorbing material was irradiated with the optical vortex laser beam was changed from 50 μJ/dot to 60 μJ/dot. The results are presented in Table 1. The flying state is depicted in FIG. 13A and the deposited state is depicted in FIG. 13B.

### Comparative Example 1

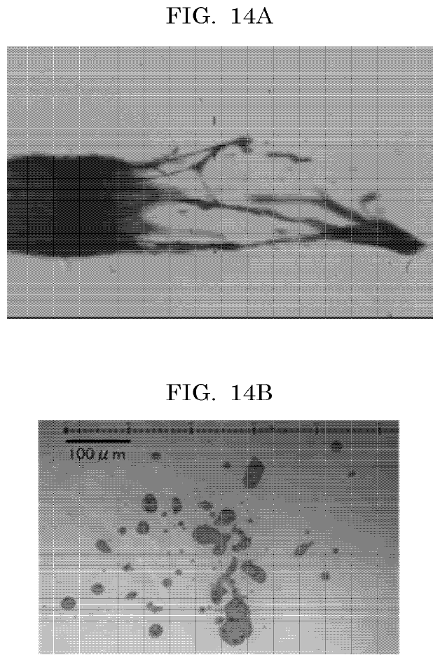

The flying state and deposited state were evaluated in the same manner as in Example 1, except that the energy adjusting filter was set in a manner that the irradiation energy when the light-absorbing material was irradiated with the optical vortex laser beam was changed from 50 μJ/dot to 70 μJ/dot. The results are presented in Table 1. The flying state is depicted in FIG. 14A and the deposited state is depicted in FIG. 14B.

### Comparative Example 2

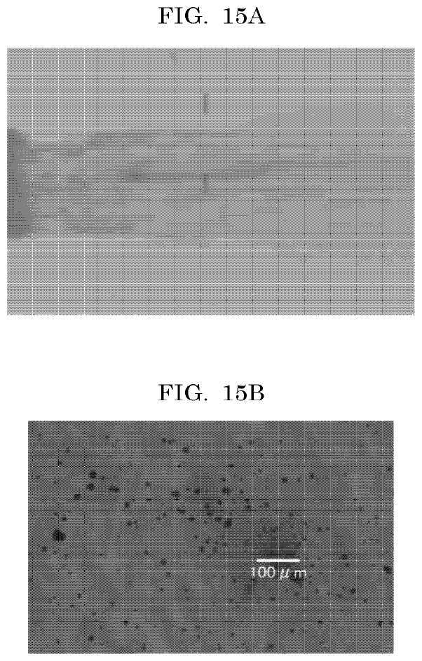

The flying state and deposited state were evaluated in the same manner as in Example 1, except that the average thickness of the film thickness of the UV ink applied to the surface of the base was changed from 20 μm to 3 μm. The results are presented in Table 1. The flying state is depicted in FIG. 15A and the deposited state is depicted in FIG. 15B. Moreover, the transmittivity of the UV ink film to light having a wavelength of 532 nm was 1% when the film thickness of the UV ink film was 3 μm.

TABLE 1

| | | | | | Gap between | | |
|---|---|---|---|---|---|---|---|
| | | | | | depositing target and | | |
| | Irradiation | | Film | | light-absorbing | | Deposited |
| | energy | | thickness | | material | Flying state | state |
| Ex. 1 | 50 | μJ/dot | 20 | μm | 1.5 mm | Good | Good |
| Ex. 2 | 60 | μJ/dot | 20 | μm | 1.5 mm | Fair | Fair |
| Ex. 3 | 50 | μJ/dot | 20 | μm | 0.2 mm | Good | Good |
| Ex. 4 | 60 | μJ/dot | 20 | μm | 0.2 mm | Good | Good |
| Comp. Ex. 1 | 70 | μJ/dot | 20 | μm | 1.5 mm | Poor | Poor |
| Comp. Ex. 2 | 50 | μJ/dot | 3 | μm | 1.5 mm | Poor | Poor |

It was found from the results in Table 1 that the flying state and deposited state of the UV ink were excellent in Examples 1, 3, and 4. In Example 2, moreover, the irradiation energy was high and the gap between the depositing target and the light-absorbing material was wide, and therefore the scattering occurred slightly more Compared to Examples 1, 3, and 4, but still excellent results were obtained.

In Comparative Example 1, on the other hand, the irradiation energy was high, and therefore the light-absorbing material (UV ink) was spread and scattered wider than the irradiation diameter of the optical vortex laser beam as illustrated in FIGS. 14A and 14B. Specifically, in Comparative Example 1, the liquid droplets having diameters smaller than the irradiation diameter of the optical vortex laser beam could not be formed.

In Comparative Example 2, moreover, the average thickness of the film of the UV ink was changed from 20 μm to 3 μm, and therefore the irradiation energy per unit volume became high, and the light-absorbing material (UV ink) was spread and scattered wider than the irradiation diameter of the optical vortex laser beam as illustrated in FIGS. 15A and 15B. Specifically, in Comparative Example 2, the liquid droplets having diameters smaller than the irradiation diameter of the optical vortex laser beam could not be formed.

As described above, the method for forming a flying body using optical vortex laser of the present disclosure can easily form a liquid column or liquid droplet having a small diameter using a material having high viscosity, as in Examples 1 to 4, by appropriately combining the parameters, such as the irradiation energy of the optical vortex laser beam, the film thickness, the gap between the depositing target and the light-absorbing material, the composition of the ink, and the viscosity of the ink. Therefore, an image of high resolution can be formed.

### Example 5

In Example 5, a UV ink serving as a light-absorbing material was irradiated with a pulse-oscillated optical vortex laser beam using a light-absorbing material flying unit having two galvanometer scanners as illustrated in FIG. 5C, unlike Examples 1 to 4 and Comparative Examples 1 and 2, to thereby form an array of dots on a depositing target.

In Example 5, moreover, the dots were formed with a gap of about 200 μm therebetween on the depositing target (non-transfer medium) by converging to give the laser beam diameter of Φ60 μm, with the scanning speed of the galvanometer scanner being 100 mm/s, and the repeating frequency of laser (pulse frequency) being 500 Hz. In Example 5, furthermore, the gap between the depositing target and the light-absorbing material was set to 0.1 mm, and the energy adjusting filter was set in a manner that the irradiation energy was to be 27 μJ/dot when the light-absorbing material was irradiated with the optical vortex laser beam.

In Example 5, the dots were formed on the depositing target in the same manner as in Example 1, except the above-described conditions.

The dots formed in Example 5 were observed under a digital microscope (VHX-5000, available from KEYENCE CORPORATION).

Moreover, the average diameter of the dots (average dot diameter), dispersion value of the diameter of dot (dot diameter), and dispersion value of dot position (dot position) were determined by analyzing the image obtained by the digital microscope.

More specifically, the average dot diameter was determined by obtaining the dot image of the light-absorbing material by the digital microscope to detect the dot region from image brightness information, calculating an area of each dot from the number of pixels in the detected dot region, determining a diameter of a circle converted from the area as a dot diameter, and calculating an average of the dot diameters.

Moreover, the dispersion value of the dot diameter was determined by obtaining the dot image of the light-absorbing material by the digital microscope to detect the dot region from the image brightness information, calculating an area of each dot from the number of pixels in the detected dot region, determining a diameter of a circle converted from the area as a dot diameter, and calculating the dispersion from the average particle diameter of the particle size distribution of each dot and standard deviation.

Furthermore, the dispersion value of the dot position was determined by obtaining the dot image of the light-absorbing material by the digital microscope to detect the dot region from the image brightness information, calculating barycentric coordinates of each dot region detected, and calculating displacement from the approximate straight line of each barycenter according to the least squares method.

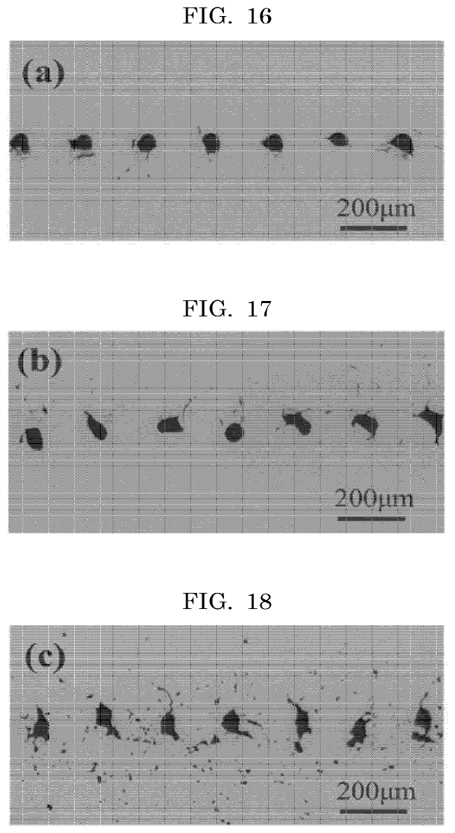

In Example 5, the average dot diameter was 67.4 μm, the dispersion value of the dot diameter was 3.4%, and the dispersion value of the dot position was 0.6 μm. The results are presented in Table 2. Moreover, the deposited state of the light-absorbing material (state of the array of dots) in Example 5 is depicted in FIG. 16.

### Example 6

In Example 6, one array of dots were formed on the depositing target in the same manner as in Example 5, except that the gap between the depositing target and the light-absorbing material was changed to 0.2 mm.

In Example 6, the average dot diameter was 69.9 μm, the dispersion value of the dot diameter was 5.3%, and the dispersion value of the dot position was 3.2 μm. The results are presented in Table 2. Moreover, the deposited state of the light-absorbing material (state of the array of dots) in Example 6 is depicted in FIG. 17.

### Example 7

In Example 7, one array of dots were formed on the depositing target in the same manner as in Example 5, except that the gap between the depositing target and the light-absorbing material was changed to 0.5 mm.

In Example 7, the average dot diameter was 75.7 μm, the dispersion value of the dot diameter was 9.0%, and the dispersion value of the dot position was 2.9 μm. The results are presented in Table 2. Moreover, the deposited state of the light-absorbing material (state of the array of dots) in Example 7 is depicted in FIG. 18.

TABLE 2

| | Gap between | | | |
|---|---|---|---|---|
| | depositing target and | | Dispersion of | Dispersion of |
| | light-absorbing | Average dot | value of dot | value of dot |
| | material | diameter | diameter | position |
| | (mm) | (μm) | (%) | (μm) |
| Ex. 5 | 0.1 | 67.4 | 3.4 | 0.6 |
| Ex. 6 | 0.2 | 69.9 | 5.3 | 3.2 |
| Ex. 7 | 0.5 | 75.7 | 9.0 | 2.9 |

When the gap between the depositing target and the light-absorbing material was 0.1 mm or 0.2 mm (Examples 5 and 6), as depicted in FIGS. 16 and 17, the shapes of the dots were particularly similar. When the gap between the depositing target and the light-absorbing material was 0.1 mm or 0.2 mm (Examples 5 and 6), moreover, the average dot diameter and the dispersion value of the dot diameter were particularly close as presented in Table 2.

As described in Examples 3 and 4, in the case where the gap between the depositing target and the light-absorbing material is 0.2 mm or less, the film of the UV ink (light-absorbing material) irradiated with the optical vortex laser beam is brought into contact with the depositing target before being cut off, followed by cutting off to form dots. Therefore, the edge of the light-absorbing material was deposited on the depositing target without being separated in Examples 5 and 6. Therefore, scattering occurred at the time of separation of the light-absorbing material was suppressed, and the dots having uniform diameters were formed.

In Example 7 where the gap between the depositing target and the light-absorbing material was 0.5 mm, moreover, the dots were formed by landing the ink droplets, which had been formed by separating the edge of the UV ink (light-absorbing material) and made the UV ink fly, on the depositing target. Therefore, scattering of the ink occurred slightly occurred in Example 7, as depicted in FIG. 18, and the dispersion of the dot diameters was slightly larger compared to Examples 5 and 6.

However, the dot shapes were sufficiently formed in Example 7 as depicted in FIG. 18, and the state thereof was significantly different from the deposited states of Comparative Examples 1 and 2, which were related art, depicted in FIGS. 14B and 15B.

The dispersion of the dot position was about 3 μm in all of Examples 5 to 7, and it was found that dots could be formed with high precision.

As described above, the method for forming a flying body using optical vortex laser of the present disclosure includes irradiating an opposite surface of a base to the surface of the base, on which a light-absorbing material is disposed, with an optical vortex laser beam to generate a liquid column or liquid droplet having a diameter smaller than an irradiation diameter of the optical vortex laser beam from the light-absorbing material in an irradiation direction of the optical vortex laser beam. Therefore, the method for forming a flying body using optical vortex laser of the present disclosure can form an image of high resolution.

For example, embodiments of the present disclosure are as follows.

<1> A method for forming a flying body using optical vortex laser, the method including:
irradiating an opposite surface of a base to a surface of the base, on which a light-absorbing material is disposed, with an optical vortex laser beam to generate a liquid column or liquid droplet having a diameter smaller than an irradiation diameter of the optical vortex laser beam from the light-absorbing material in an irradiation direction of the optical vortex laser beam.
<2> The method according to <1>,
wherein the irradiation direction of the optical vortex laser beam relative to the surface of the base is a nongravitational direction, and the liquid column or the liquid droplet is generated in the nongravitational direction.
<3> An image forming method including:
irradiating an opposite surface of a base to a surface of the base, on which a light-absorbing material is disposed, with an optical vortex laser beam to generate a liquid column or a liquid droplet having a diameter smaller than an irradiation diameter of the optical vortex laser beam from the light-absorbing material in an irradiation direction of the optical vortex laser beam; and
bringing the liquid column or the liquid droplet into contact with a transfer medium to transfer the liquid column or the liquid droplet onto the transfer medium.
<4> The image forming method according to <3>,
wherein the irradiation direction of the optical vortex laser beam relative to the surface of the base is a nongravitational direction, and the liquid column or the liquid droplet is generated in the nongravitational direction.
<5> The image forming method according to <3> or <4>,
wherein, when the surface of the base is irradiated with the optical vortex laser beam, the light-absorbing material is swollen in a substantially dorm shape in the irradiation direction of the optical vortex laser beam along rotational movement of the light-absorbing material, and the liquid column or liquid droplet having the diameter smaller than the irradiation diameter of the optical vortex laser beam is generated from an apex of the substantially dorm shape.
<6> The image forming method according to any one of <3> to <5>,
wherein absorbance of the light-absorbing material to a wavelength of the optical vortex laser beam is greater than 1.
<7> The image forming method according to any one of <3> to <6>,
wherein a thickness of the light-absorbing material disposed on the surface of the base is 10 μm or greater.
<8> The image forming method according to any one of <3> to <7>,
wherein the irradiation diameter of the optical vortex laser beam is 100 μm or less.
<9> The image forming method according to any one of <3> to <8>,
wherein irradiation energy of the optical vortex laser beam is 60 μJ/dot or less.
<10> An image forming apparatus including:
a light-absorbing material flying unit configured to irradiate an opposite surface of a base to a surface of the base, on which a light-absorbing material is disposed, with an optical vortex laser beam to generate a liquid column or a liquid droplet having a diameter smaller than an irradiation diameter of the optical vortex laser beam from the light-absorbing material in an irradiation direction of the optical vortex laser beam; and a transferring unit configured to bring the liquid column or the liquid droplet into contact with a transfer medium to transfer the liquid column or the liquid droplet onto the transfer medium.

The method for forming a flying body using optical vortex laser according to <1> or <2>, the image forming method according to any one of <3> to <9>, and the image forming apparatus according to <10> can solve the above-described various problems existing in the art, and can achieve the object of the present disclosure.

What is claimed is:

1. A method for forming a flying body using optical vortex laser, the method comprising:
irradiating an opposite surface of a base to a surface of the base, on which a light-absorbing material is disposed, with an optical vortex laser beam to generate a liquid column or liquid droplet having a diameter smaller than an irradiation diameter of the optical vortex laser beam from the light-absorbing material in an irradiation direction of the optical vortex laser beam.

2. The method according to claim 1,
wherein the irradiation direction of the optical vortex laser beam relative to the surface of the base is a nongravitational direction, and the liquid column or the liquid droplet is generated in the nongravitational direction.

3. An image forming method comprising:
irradiating an opposite surface of a base to a surface of the base, on which a light-absorbing material is disposed, with an optical vortex laser beam to generate a liquid column or a liquid droplet having a diameter smaller than an irradiation diameter of the optical vortex laser beam from the light-absorbing material in an irradiation direction of the optical vortex laser beam; and
bringing the liquid column or the liquid droplet into contact with a transfer medium to transfer the liquid column or the liquid droplet onto the transfer medium.

4. The image forming method according to claim 3,
wherein the irradiation direction of the optical vortex laser beam relative to the surface of the base is a nongravitational direction, and the liquid column or the liquid droplet is generated in the nongravitational direction.

5. The image forming method according to claim 3,
wherein, when the surface of the base is irradiated with the optical vortex laser beam, the light-absorbing material is swollen in a substantially dorm shape in the irradiation direction of the optical vortex laser beam along rotational movement of the light-absorbing material, and the liquid column or liquid droplet having the diameter smaller than the irradiation diameter of the optical vortex laser beam is generated from an apex of the substantially dorm shape.

6. The image forming method according to claim 3,
wherein absorbance of the light-absorbing material to a wavelength of the optical vortex laser beam is greater than 1.

7. The image forming method according to claim 3,
wherein a thickness of the light-absorbing material disposed on the surface of the base is 10 μm or greater.

8. The image forming method according to claim 3,
wherein the irradiation diameter of the optical vortex laser beam is 100 μm or less.

9. The image forming method according to claim 3,
wherein irradiation energy of the optical vortex laser beam is 60 μJ/dot or less.

10. An image forming apparatus comprising:
a light-absorbing material flying unit configured to irradiate an opposite surface of a base to a surface of the base, on which a light-absorbing material is disposed, with an optical vortex laser beam to generate a liquid column or a liquid droplet having a diameter smaller than an irradiation diameter of the optical vortex laser beam from the light-absorbing material in an irradiation direction of the optical vortex laser beam; and
a transferring unit configured to bring the liquid column or the liquid droplet into contact with a transfer medium to transfer the liquid column or the liquid droplet onto the transfer medium.
